(19) United States
(12) Patent Application Publication
(10) Pub. No.: US 2025/0056364 A1
(43) Pub. Date: Feb. 13, 2025

(54) METHODS AND APPARATUSES FOR MOBILITY MANAGEMENT

(71) Applicant: SHARP KABUSHIKI KAISHA, Osaka (JP)

(72) Inventors: He-Hsuan Liu, Taipei (TW); Mei-Ju Shih, Taipei (TW); Yen-Hua Li, Taipei (TW)

(21) Appl. No.: 18/795,655

(22) Filed: Aug. 6, 2024

Related U.S. Application Data
(60) Provisional application No. 63/531,221, filed on Aug. 7, 2023.

(51) Int. Cl. H04W 36/32; H04W 36/00; H04W 36/36; H04W 76/30

(52) U.S. Cl. CPC H04W 36/324; H04W 36/0072; H04W 36/362; H04W 76/30

(57) ABSTRACT

Methods and apparatuses for mobility management are provided. The method includes receiving, from a network, a first conditional configuration for a candidate target Primary Cell (PCell). The first conditional configuration indicates an execution condition. The method determines whether the execution condition is satisfied and in response to determining that the execution condition is satisfied, applies the first conditional configuration to switch to the candidate target PCell. The method then, after switching to the candidate target PCell, determines whether to release a second conditional configuration, which has been stored at the UE prior to switching to the candidate target PCell, based on whether the second conditional configuration is associated with the first conditional configuration.

### CROSS-REFERENCE TO RELATED APPLICATION(S)

The present disclosure claims the benefit of and priority to U.S. Provisional Patent Application Ser. No. 63/531,221, filed on Aug. 7, 2023, entitled “METHOD AND APPARATUS FOR SELECTIVE ACTIVATION OF CELL GROUPS,” the content of which is hereby incorporated herein fully by reference into the present disclosure for all purposes.

### FIELD

The present disclosure is related to wireless communication and, more specifically, to methods and apparatuses for mobility management.

### BACKGROUND

Various efforts have been made to improve different aspects of wireless communication for cellular wireless communication systems, such as the 5th Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). As the demand for radio access continues to increase, however, there exists a need for further improvements in the art.

### SUMMARY

The present disclosure is related to methods and apparatuses for mobility management.

According to a first aspect of the present disclosure, a method performed by a User Equipment (UE) for mobility management is provided. The method includes receiving, from a network, a first conditional configuration for a candidate target Primary Cell (PCell), the first conditional configuration indicating an execution condition; determining whether the execution condition is satisfied; in response to determining that the execution condition is satisfied, applying the first conditional configuration to switch to the candidate target PCell; and in response to switching to the candidate target PCell, determining whether to release a second conditional configuration, which has been stored at the UE prior to switching to the candidate target PCell, based on whether the second conditional configuration is associated with the first conditional configuration.

In some implementations of the first aspect of the present disclosure, the method further includes retaining, after switching to the candidate target PCell, the second conditional configuration in response to determining that the second conditional configuration is associated with the first conditional configuration; and releasing, after switching to the candidate target PCell, the second conditional configuration in response to determining that the second conditional configuration is not associated with the first conditional configuration.

In some implementations of the first aspect of the present disclosure, the second conditional configuration is associated with a candidate target Primary Secondary Cell (PSCell).

In some implementations of the first aspect of the present disclosure, applying the first conditional configuration to switch to the candidate target PCell includes performing a Random Access (RA) procedure based on the first conditional configuration.

According to a second aspect of the present disclosure, a User Equipment (UE) for mobility management is provided. The UE includes at least one processor and at least one non-transitory computer-readable medium coupled to the at least one processor. The at least one non-transitory computer-readable medium stores one or more computer-executable instructions that, when executed by the at least one processor, cause the UE to receive, from a network, a first conditional configuration for a candidate target Primary Cell (PCell), the first conditional configuration indicating an execution condition; determine whether the execution condition is satisfied; apply the first conditional configuration to switch to the candidate target PCell in response to determining that the execution condition is satisfied; and in response to switching to the candidate target PCell, determine whether to release a second conditional configuration, which has been stored at the UE prior to switching to the candidate target PCell, based on whether the second conditional configuration is associated with the first conditional configuration.

In some implementations of the second aspect of the present disclosure, the one or more computer-executable instructions, when executed by the at least one processor, further cause the UE to retain, after switching to the candidate target PCell, the second conditional configuration in response to determining that the second conditional configuration is associated with the first conditional configuration; and release, after switching to the candidate target PCell, the second conditional configuration in response to determining that the second conditional configuration is not associated with the first conditional configuration.

In some implementations of the second aspect of the present disclosure, the second conditional configuration is associated with a candidate target Primary Secondary Cell (PSCell).

In some implementations of the second aspect of the present disclosure, applying the first conditional configuration to switch to the candidate target PCell includes performing a Random Access (RA) procedure based on the first conditional configuration.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a flowchart of a method/process for mobility management, according to an example implementation of the present disclosure.

FIG. 2 is a flowchart of a method/process for mobility management, according to an example implementation of the present disclosure.

FIG. 3 is a block diagram illustrating a node for wireless communication, according to an example implementation of the present disclosure.

### DESCRIPTION

Some of the abbreviations used in this disclosure include:

| Abbreviation | Full name |
|---|---|
| 3GPP | 3^{rd} Generation Partnership Project |
| 5G | 5^{th} Generation |
| 5GC | 5G Core |
| ACK | Acknowledgement |
| AN-PDB | Access Network Packet Delay Budget |
| AS | Access Stratum |
| ASN.1 | Abstract Syntax Notation One |
| BFRQ | Beam Failure Recovery Request |
| BS | Base Station |
| BSR | Buffer Status Report |
| BWP | Bandwidth Part |
| C-RNTI | Cell Radio Network Temporary Identifier |
| CA | Carrier Aggregation |
| CAG | Closed Access Group |
| CB | Codebook-Based |
| CG | Configured Grant |
| CHO | Conditional Handover |
| CJT | Coherent Joint Transmission |
| CN | Core Network |
| CN-PDB | Core Network Packet Delay Budget |
| CORESET | Control Resource Set |
| CPA | Conditional Primary Secondary Cell Addition |
| CPAC | Conditional Primary Secondary Cell Addition |
| | and/or Change |
| CPC | Conditional Primary Secondary Cell Change |
| CPASA | Conditional Primary Secondary Cell Addition with a |
| | Selective Activation |
| CPCSA | Conditional Primary Secondary Cell Change with a |
| | Selective Activation |
| CPE | Customer Premises Equipment |
| CRC | Cyclic Redundancy Check |
| CSI | Channel State Information |
| CSI-RS | Channel State Information Reference Signal |
| CS-RNTI | Configured Scheduling Radio Network Temporary |
| | Identifier |
| CSS | Common Search Space |
| CU | Central Unit |
| DAPS | Dual Active Protocol Stack |
| DC | Dual Connectivity |
| DCI | Downlink Control Information |
| DG | Dynamic Grant |
| DI | Delay Information |
| DL | Downlink |
| DL-SCH | Downlink Shared Channel |
| DMRS | Demodulation Reference Signal |
| DR | Delay Report |
| DRB | Data Radio Bearer |
| DTCH | Dedicated Traffic Channel |
| DU | Distributed Unit |
| ETSI | European Telecommunications Standards Institute |
| E-UTRA | Evolved Universal Terrestrial Radio Access |
| EN-DC | E-UTRA NR Dual Connectivity |
| EPC | Evolved Packet Core |
| eMBB | Enhanced Mobile BroadBand |
| eMTC | Enhanced Machine Type Communication |
| eNB | Evolved Node B |
| FDD | Frequency Division Duplexing |
| FR | Frequency Range |
| FR1 | Frequency Range 1 |
| FR2 | Frequency Range 2 |
| FWA | Fixed Wireless Access |
| GEO | Geostationary Equatorial Orbit |
| gNB | Next Generation Node B |
| GNSS | Global Navigation Satellite System |
| GW | Gateway |
| HARQ | Hybrid Automatic Repeat Request |
| HO | Handover |
| FR | Frequency Range |
| IAB | Integrated Access and Backhaul |
| ID | Identity |
| IE | Information Element |
| IoT | Internet of Things |
| ITS | Intelligent Transportation System |
| ITU | International Telecommunication Union |
| L1 | Layer 1 |
| L2 | Layer 2 |
| L3 | Layer 3 |
| LAN | Local Area Network |
| LCH | Logical Channel |
| LCID | Logical Channel Identity |
| LEO | Low Earth Orbit |
| LTE | Long Term Evolution |
| MAC | Medium Access Control |
| MAC CE | MAC Control Element |
| MCG | Master Cell Group |
| MCS | Modulation Coding Scheme |
| MIB | Master Information Block |
| MIMO | Multi-Input Multi-Output |
| mMTC | Massive Machine Type Communications |
| MN | Master Node |
| MR-DC | Multi-Radio Access Technology Dual Connectivity |
| MTC | Machine Type Communication |
| NACK | Negative Acknowledgement |
| NAS | Non-Access Stratum |
| NB-IoT | Narrow Band Internet of Things |
| NCB | Non-Codebook-Based |
| NDI | New Data Indicator |
| NE-DC | NR-E-UTRA Dual Connectivity |
| NGEN-DC | NG-RAN E-UTRA-NR Dual Connectivity |
| NR | New Radio |
| NR-DC | New Radio-Dual Connectivity |
| NR-U | NR Unlicensed |
| NTN | Non-Terrestrial Network |
| PBCH | Physical Broadcast Channel |
| PCell | Primary Cell |
| PCI | Physical Cell Identity |
| PDB | Packet Delay Budget |
| PDCCH | Physical Downlink Control Channel |
| PDCP | Packet Data Convergence Protocol |
| PDSCH | Physical Downlink Shared Channel |
| PDU | Protocol Data Unit |
| PHY | Physical |
| PLMN | Public Land Mobile Network |
| PNI-NPN | Public Network Integrated Non-Public Network |
| PRACH | Physical Random Access Channel |
| PSCell | Primary Secondary Cell Group Cell |
| PSDB | PDU Set Delay Budget |
| PUCCH | Physical Uplink Control Channel |
| PUSCH | Physical Uplink Shared Channel |
| QCL | Quasi-CoLocation |
| QoS | Quality of Service |
| RA | Random Access |
| RACH | Random Access Channel |
| RAN | Radio Access Network |
| RAR | Random Access Response |
| RAT | Radio Access Technology |
| Rel-15 | Release 15 |
| RF | Radio Frequency |
| RLC | Radio Link Control |
| RS | Reference Signal |
| RLF | Radio Link Failure |
| RSTD | Reference Signal Time Difference Measurement |
| RNTI | Radio Network Temporary Identifier |
| RO | RACH Occasion |
| RRC | Radio Resource Control |
| RS | Reference Signal |
| RSRP | Reference Signal Received Power |
| RSRQ | Reference Signal Receiving Quality |
| RX | Reception |
| SA | Selective Activation |
| SCell | Secondary Cell |
| SCG | Secondary Cell Group |
| SDAP | Service Data Adaptation Protocol |
| SDT | Small Data Transmission |
| SI | System Information |
| SIB | System Information Block |
| SL | Sidelink |
| SLIV | Start and Length Indicator Value |
| SN | Secondary Node |
| SNPN | Stand-alone Non-Public Network |
| SpCell | Special Cell |
| SR | Scheduling Request |
| SRB | Signaling Radio Bearer |
| SRS | Sounding Reference Signal |
| SRI | SRS Resource Indicator |
| SSB | Synchronization Signal Block |
| SUL | Supplementary Uplink |
| TA | Tracking Area |
| TAG | Timing Advance Group |
| TAT | Time Alignment Timer |
| TB | Transport Block |
| TCI | Transmission Configuration Indication |
| TDD | Time Division Duplexing |
| TN | Terrestrial Network |
| TPC | Transmission Power Control |
| TPMI | Transmit Precoder Matrix Indication |
| TRP | Transmission Reception Point |
| TRS | Tracking Reference Signal |
| TS | Technical Specification |
| TTT | Time-to-Trigger |
| TX | Transmission |
| UCI | Uplink Control Information |
| UE | User Equipment |
| UL | Uplink |
| UL-CG | Uplink-Configured Grant |
| UPF | User Plane Function |
| URLLC | Ultra-Reliable and Low-Latency Communications |
| USIM | Universal Subscriber Identity Module |
| USS | UE-specific Search Space |
| V2X | Vehicle-to-Everything |
| VSAT | Very Small Aperture Terminal |
| XnAP | Xn Application Protocol |
| XR | Extended Reality |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not illustrated) by the same numerals in the drawings. However, the features in different implementations may be different in other respects and shall not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “in one implementation,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic.

The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS may be operable to provide radio coverage to a specific geographical area using a plurality of cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may include the SpCell of an MCG. A Primary SCG Cell (PSCell) may include the SpCell of an SCG. MCG may include a group of serving cells associated with the MN, including the SpCell and optionally one or more Secondary Cells (SCells). An SCG may include a group of serving cells associated with the SN, including the SpCell and optionally one or more SCells.

As described above, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

“A and/or B” in the present disclosure may refer to either A or B, both A and B, or at least one of A and B.

Multiple PLMNs may be operated on the unlicensed spectrum. Multiple PLMNs may share the same unlicensed carrier. The PLMNs may be public or private. Public PLMNs (e.g., provided by operators and/or virtual operators) may provide radio services to public subscribers. Public PLMNs may own licensed spectrum and also support radio access technology on the licensed spectrum. Private PLMNs (e.g., provided by micro-operators, factories, and/or enterprises) may provide radio services to their private users (e.g., employees or machines). In some implementations, public PLMNs may support more deployment scenarios. These scenarios may include carrier aggregation between licensed band NR (e.g., the PCell) and NR-U (e.g., the SCell), dual connectivity between licensed band LTE (e.g., the PCell) and NR-U (e.g., the PSCell), stand-alone NR-U, an NR cell with DL in the unlicensed band and UL in the licensed band, and dual connectivity between licensed band NR (e.g., the PCell) and NR-U (e.g., the PSCell). In some implementations, private PLMNs mainly support, but are not limited to, stand-alone unlicensed radio access technology, such as stand-alone NR-U.

The terms, definitions, and abbreviations included in the present disclosure are either sourced from existing documents (such as those from ETSI, ITU, or other sources) or newly created by experts from the 3GPP whenever there was a need for precise vocabulary.

Examples of some selected terms in the present disclosure are provided as follows.

The terms “network (NW),” “cell,” “camped cell,” “serving cell,” “Base Station (BS),” “gNB,” “eNB” and “ng-eNB” may be used interchangeably. In some implementations, some of these items may include the same network entity.

A RAT may include, but is not limited to, an NR, an LTE, an E-UTRA connected to the 5GC, an LTE connected to the 5GC, E-UTRA connected to EPC, and an LTE connected to the EPC. The mechanisms, methods, and/or approaches described in the present disclosure may be applicable to the UEs operating in the public networks or in the private networks (e.g., NPNs, SNPNs, and/or PNI-NPNs).

The mechanisms, methods, and/or approaches described in the present disclosure may be applicable to the licensed frequency and/or the unlicensed frequency. In addition, the mechanism of conditional configuration selection described in the present disclosure may be applied for the cases in which a UE experiences a radio link failure when configured with the conditional configuration(s).

System information (SI) may include the MIB, the SIB1, or other SI. Minimum SI may include the MIB and the SIB1. Other SI may include SIB3, SIB4, SIB5, or other SIB(s).

Dedicated signaling may include, but is not limited to, one or more RRC messages. Examples of the RRC signaling or RRC message(s) may include the RRC (Connection) Setup Request message, the RRC (Connection) Setup message, the RRC (Connection) Setup Complete message, the RRC (Connection) Reconfiguration message, the RRC Connection Reconfiguration message including the mobility control information, the RRC Connection Reconfiguration message without the mobility control information inside, the RRC

Reconfiguration message including the configuration with sync, the RRC Reconfiguration message without the configuration with sync inside, the RRC (Connection) Reconfiguration Complete message, the RRC (Connection) Resume Request message, the RRC (Connection) Resume message, the RRC (Connection) Resume Complete message, the RRC (Connection) Reestablishment Request message, the RRC (Connection) Reestablishment message, the RRC (Connection) Reestablishment Complete message, the RRC (Connection) Reject message, the RRC (Connection) Release message, the RRC System Information Request message, the UE Assistance Information message, the UE Capability Enquiry message, and UE Capability Information message.

The mechanisms, methods, and/or approaches described in the present disclosure may be applicable to the RRC_CONNECTED UE (e.g., the UE in the RRC_CONNECTED state), the RRC_INACTIVE UE (e.g., the UE in the RRC_INACTIVE state), and the RRC_IDLE UE (e.g., the UE in the RRC_IDLE state).

A source cell may include a suitable cell or an acceptable cell.

The UE may be served by a cell, e.g., a serving cell. The serving cell may serve an RRC_CONNECTED UE, among other types of UEs. The serving cell may include (but is not limited to) a suitable cell.

PCell: an MCG cell, operating on the primary frequency, in which the UE either performs the initial connection establishment procedure or initiates the connection re-establishment procedure.

PSCell: an SCG cell used for dual connectivity operation, in which the UE may perform an RA procedure when performing the Reconfiguration with the synchronization (Sync) procedure.

Serving Cell: for a UE in the RRC_CONNECTED state not configured with CA/DC, there is only one serving cell consisting of the primary cell. For a UE in the RRC_CONNECTED state configured with CA/DC, the term “serving cells” is used to denote the set of cells consisting of the Special Cell(s) and all secondary cells.

Secondary Cell: for a UE configured with CA, the secondary cell may include the cell that provides additional radio resources on top of the Special Cell.

SpCell: for the DC operation, the Special Cell may include the PCell of the MCG or the PSCell of the SCG, otherwise the Special Cell may include the PCell.

MCG: in MR-DC, the MCG may include a group of serving cells associated with the MN, consisting of the SpCell (e.g., the PCell) and optionally one or more SCells.

MN: in MR-DC, the MN may include the radio access node that provides the control plane connection to the core network. The MN may include a Master eNB (in EN-DC), a Master ng-eNB (in NGEN-DC), or a Master gNB (in NR-DC and NE-DC).

SCG: in MR-DC, the SCG may include a group of serving cells associated with the SN, consisting of the SpCell (e.g., the PSCell) and optionally one or more SCells.

SN: in MR-DC, the SN may include the radio access node, with no control plane connection to the core network, providing additional resources to the UE. The SN may include an en-gNB (in EN-DC), a Secondary ng-eNB (in NE-DC) or a Secondary gNB (in NR-DC and NGEN-DC). en-gNB is a node providing NR user plane and control plane protocol terminations towards the UE, and acting as an SN in EN-DC.

The serving cell described in the present disclosure may include a PCell, an SCell or a PSCell.

The source node described in the present disclosure may include at least one of the following: a source MN, a source SN, a source gNB, a source eNB, a source PCell, a source PSCell, and a source SCell.

The target cell described in the present disclosure may include a PCell, an SCell or a PSCell.

The inter-cell relative to the serving cell of the UE may include a neighboring cell, a cell other than the serving cell or a cell with a PCI different from the PCI of the serving cell. If the UE is capable of performing inter-cell beam managements, the UE may be in the coverage area of the inter-cell.

An RRC_CONNECTED UE may be configured with an active BWP with a common search space configured to monitor the system information or the paging.

The UE may be served by a cell (e.g., serving cell). The serving cell may serve an RRC_CONNECTED UE. The serving cell may include, but is not limited to, a suitable cell.

A suitable cell may include a cell on which a UE may camp. The UE may consider a cell as a suitable cell if the following conditions are fulfilled: (1) the cell is part of either the selected PLMN or the registered PLMN or the PLMN of the equivalent PLMN list, and (2) the cell criteria of the cell are fulfilled. Furthermore, according to the latest information provided by the NAS, the suitable cell may not be barred. The suitable cell may be part of at least one TA that is not part of the list of “Forbidden Tracking Areas,” which belongs to the PLMN that fulfils the condition (1).

An acceptable cell may include a cell on which the UE may camp to obtain the limited services (e.g., originate emergency calls and receptions of ETWS and CMAS notifications). Such a cell may fulfil the following requirements, which is the minimum set of requirements to initiate an emergency call and to receive ETWS and CMAS notification in an NR network: (1) the cell is not barred, and/or (2) the cell selection criteria are fulfilled.

The target cell may include a suitable cell.

The candidate target MN may include the MN associated with the candidate target PCells.

The candidate target SN may include the SN associated with the candidate target PSCells.

A CPAC may include a CPA, a CPC, or both.

A single SA counter may be associated to a PSCell, an SCG configuration, multiple PSCells, and/or multiple SCG configurations.

The inter-node signaling (e.g., between the MN and the SN) in some implementations may include the RRC signaling or the XnAP signaling.

In the present disclosure, although the term “gNB” is used throughout the document, it should be understood that the term “gNB” can be replaced by any other type of BS (e.g., an eNB).

In wireless cellular networks, the MR-DC may enable one or more mobile devices (e.g., one or more UEs) to connect to at least two network nodes, such as an MN and at least one SN. The MN and/or the SN may include one or more cells, and the network may configure a mobile device with a group of cells called MCG in the MN and another group of cells called SCG in the SN. It is possible that the network may include one MN and at least one SN, which means that the mobile device may be configured with one MCG and at least one SCG, where each SCG is in the SN. The mobile device may maintain the control and the user plane connections to the PCell among the MCG in the MN and to the PSCell among the SCG in the SN.

The mobile devices may move from one cell to another due to their mobility. When a mobile device moves from a serving cell to a neighboring cell, a mobility event may occur. For example, the quality of the signal received from the source cell falls below a threshold for a period. A handover procedure may then be needed to ensure that the mobile device is able to continue the ongoing service in the neighboring cell. The neighboring cell may include a cell close to the source cell. For a mobile device, it is possible that the mobility event for the PSCell may occur, whereas the mobility event for the PCell may not occur. In such cases, the mobile device may change the PSCell while maintaining the connection to the serving PCell, and the procedure may be called a PSCell change or a PSCell change procedure. The PSCell change procedure may be further enhanced to become a CPC or a CPC procedure. In the CPC procedure, a mobile device may be configured with (e.g., through multiple CPC configurations) multiple candidate target PSCell configurations and the execution conditions corresponding to the candidate target PSCell configurations. Once an execution condition is satisfied, the mobile device may apply the corresponding PSCell configuration to construct the connection to the PSCell.

In addition to the CPC procedure, there is also a conditional procedure for the MR-DC operation, referring to as a CPA or a CPA procedure. For a mobile device operating in the standalone mode (e.g., the mobile device is only connecting to the MN), the network may configure the UE with multiple candidate PSCells, which may belong to different SNs, and the execution conditions corresponding to the candidate PSCells, through multiple CPA configurations. Once an execution condition is satisfied, the mobile device may apply the corresponding PSCell configuration to establish the connection to the PSCell and start operating in the MR-DC.

A CPAC (or a CPAC procedure) with an SCG selective activation may include, but is not limited to, an initial CPAC preparation step with the SCG selective activation and multiple subsequent CPAC evaluation and execution steps. During the CPAC evaluation and execution step, the UE may perform evaluation to determine whether to execute the CPAC. In some implementations, the initial preparation step may include the initial CPAC with the SCG selective activation preparation step, and the initial preparation may include the initial CPAC with the SCG selective activation preparation. For example, the preparation may include determining the radio resource configuration for the candidate PSCell/SCG and performing the signaling exchange to facilitate the determination of the radio resource configuration. The CPAC with the SCG selective activation may be used to reduce the reconfigurations of the CPAC candidate(s) by allowing the UE to retain the stored CPAC candidate configuration(s) after executing the CPAC. The terms “CPAC procedure with the SCG selective activation” and “CPCSA” may be utilized interchangeably in the present disclosure.

In the present disclosure, the following scenario may be considered: a network includes multiple cells, and a UE supports the MR-DC configuration. This means that the UE is able to receive service data from at least two RAN nodes, for example, an MN including an MCG and at least one SN including an SCG. In the present disclosure, the terms “MN” and “master gNB” may be utilized interchangeably; the terms “SN” and “secondary gNB” may be utilized interchangeably. The UE may be configured with multiple receivers and transmitters and may be capable of supporting the MR-DC-dedicated configurations. The network, aware of the UE's capabilities, may configure the UE with an MR-DC configuration (e.g., the SCG configuration) that is encapsulated in an RRC reconfiguration message and that is transmitted from the serving gNB/cell to the UE. In this scenario, the UE may operate with the MR-DC configuration if the MR-DC is configured by the network, or may not operate with the MR-DC configuration if the MR-DC is not configured by the network.

If the UE is configured with the MR-DC and is operating with the MR-DC configuration, the network may utilize the radio resources provided by two distinct schedulers located in different RAN nodes. The UE may maintain the control and user plane connections to the PCell in the MCG and to the PSCell in the SCG. From the UE's perspective, there may be three types of bearers for the user plane: the MCG bearer, the SCG bearer, and the split bearer. From the network's perspective, each bearer may terminate either in the MN or the SN.

As discussed above, in wireless cellular networks, mobile devices (e.g., UE) may move from a cell to another due to their mobility. When a mobile device moves from a serving cell to a neighboring cell, a mobility event may occur, e.g., the quality of signal received from the source cell falls below a threshold for a period. A handover procedure may then be needed to ensure that the mobile device can continue the ongoing service in the neighboring cell. Typically, the handover procedure may be triggered by L3 measurements and is completed with RRC signaling.

To further enhance the robustness of the handover procedure, the Conditional Handover (CHO) is proposed to ensure that a mobile device is configured with a configuration of the target cell in advance, e.g., when the signal quality between the mobile device and the source cell is still stable.

There is a regular handover procedure for the Multi-Radio Dual Connectivity (MR-DC) scenario, e.g., using the RRC Reconfiguration messages to configure the change of Primary Cell (PCell) and Primary Secondary Cell (PSCell), and to configure the addition and/or the release of Secondary Cells (SCells). However, the CHO and the MR-DC cannot be configured simultaneously according to the current 3GPP specification. The restriction may limit the usefulness of the CHO feature when the MR-DC scenario is configured. As a result, it is desirable to provide a mechanism for the simultaneous configuration of the CHO and the MR-DC to enhance the mobility robustness.

While specifying the simultaneous configuration of the CHO and the MR-DC may be desirable, it may not be sufficient to fully optimize the MR-DC mobility. This is because the signal quality of the conditionally configured PSCell may not be optimal when the mobile device accesses the target PCell. In such cases, the throughput of the mobile device may be impacted negatively. To address this issue, an enhancement known as CHO with a CPAC is being considered.

An aspect of the present disclosure focuses on enhancing the CPAC procedure through two approaches: (1) a subsequent CHO with a CPAC and (2) a CHO with a subsequent CPAC. This enhancement is designed to optimize the network performance and efficiency. A feature of the proposed procedure is its ability to reduce the network control signaling overhead. This may be achieved by allowing the UE to keep partial or complete information of a conditional configuration after executing one of the conditional configurations. By retaining the information, the UE would be able to potentially streamline future handover processes, leading to more efficient usage of network resources and improved mobility management in complex network environments. In the present disclosure, the terms “keep,” “maintain,” and “retain” are used interchangeably to describe the process of information preservation.

Conditional Handover with Conditional PSCell Addition/Change

A CHO that involves a target MCG and one or more candidate SCGs for a CPC or a CPA in the NR-DC scenario may be referred to as a CHO with a CPAC. This terminology, however, is not exclusive. For the purposes of this disclosure, the terms “a CHO including a target MCG and candidate SCGs for a CPC/CPA in NR-DC” and “a CHO with a CPAC” may be used interchangeably. This equivalence in terminology allows for a consistent understanding of the concept throughout the disclosure, regardless of which specific phrase is used to describe this particular type of CHO in the NR-DC environments.

### Selective Activation of an MCG and an SCG

In a CHO with a CPAC, a UE may be configured with one or multiple conditional configurations including different execution conditions for two different cells (e.g., a PCell and a PSCell) and the corresponding MCG and SCG configurations. By configuring the selective activation of the MCG and the SCG, a UE may keep/maintain partial or complete information in the CHO-with-CPAC configurations when the UE completes the execution of one of the configured conditional configurations.

In some implementations, the CHO-with-CPAC configuration may include a configuration and/or an IE that includes the candidate target PCell(s), the associated candidate target PSCell(s), the execution condition(s) for the candidate target PCell(s), the execution condition(s) for the candidate target PSCell(s), the MCG configuration for the candidate target PCell(s), and/or the SCG configuration for the associated candidate target PSCell(s).

The selective activation of the MCG and the SCG may be further categorized into two scenarios: (1) a subsequent CHO with a CPAC and (2) a CHO with a subsequent CPAC. In the case of a subsequent CHO with a CPAC, the UE may retain the complete CHO-with-CPAC configuration. Conversely, in the case of a CHO with a subsequent CPAC, the UE may remove the execution condition associated with the CHO while retaining the remaining information within the CHO-with-CPAC configuration.

### Preparation for the Selective Activation of the MCG and the SCG

In some implementations, the source node (e.g., the source MN) may initiate a CHO with a CPAC in response to the UE indicating its capability to support this feature. The source node (e.g., the source MN) may determine a list of target PCells according to the measurement report received from the UE via RRC signaling. The source node (e.g., the source MN) may transmit an XnAP message (Message 1) to the MNs associated with the candidate target PCells. In some implementations, the candidate target MN may include the MN associated with one or more candidate target PCells. In some implementations, the candidate target MN may determine the candidate target PCells and the associated PSCells and may prepare the radio resource configuration for each candidate target PCell (e.g., by determining the radio resource configuration associated with each of the candidate target PCells).

The candidate target MN may transmit an XnAP message (Message 2) to the SNs associated with the candidate target PSCells. In some implementations, the candidate target SN may include the SN associated with one or more candidate target PSCells. The candidate target SN may determine the candidate target PSCells and may prepare the radio resource configuration for each candidate target PSCell. The candidate target SN may then transmit an XnAP message (Message 3) to the candidate target MN. Upon receiving the messages from all the associated candidate target SNs, the candidate target MN may transmit an XnAP message (Message 4) to the source node (e.g., the source MN). It should be noted that a candidate target MN may lead (or involve or be associated with) the corresponding candidate target PCells. A candidate target SN may lead (or involve or be associated with) the corresponding candidate target PSCells.

In some implementations, the Message 1 may additionally include an indication that indicates the allowability of the selective activation of the MCG and the SCG.

In some implementations, after receiving the Message 3 from all the associated candidate target SNs, if indicated in the Message 1 that the preparation allows the selective activation of the MCG and the SCG, the candidate target MN may determine whether each of the prepared CHO-with-CPAC configurations is used for the selective activation of the MCG and the SCG, and the candidate target MN may determine the selective activation type of each prepared CHO-with-CPAC configuration.

In some implementations, the Message 4 may additionally include an indication that indicates the selective activation type(s) of the prepared CHO-with-CPAC configurations.

In some implementations, the terminology “SA type indicator” may be used to represent such an indication.

In some implementations, for each prepared CHO-with-CPAC configuration, the SA type indicator may be included in the CHO-with-CPAC configuration and may utilize an ENUMERATED format with a value {′SUBSEQUENT_CHO′, ‘SUBSEQUENT_CPAC’, ‘FALSE’}.

In some implementations, the SA type indicator with a value of ‘SUBSEQUENT_CHO’ may indicate that the CHO-with-CPAC configuration may be completely kept and used for the selective activation of the MCG and the SCG.

In some implementations, the SA type indicator with a value of ‘SUBSEQUENT_CPAC’ may indicate that the CHO-with-CPAC configuration may be partially kept and used for the selective activation of the MCG and the SCG.

In some implementations, the SA type indicator with a value of ‘FALSE’ may indicate that the CHO-with-CPAC configuration may be released and may not be used for the selective activation of the MCG and the SCG.

In some implementations, the SA type indicator may be an IE, different from the IE of the corresponding prepared CHO-with-CPAC configuration, and the SA type indicator may utilize an ENUMERATED format, allowing it to take one of three possible values: {′SUBSEQUENT_CHO′, ‘SUBSEQUENT_CPAC’, ‘FALSE’}.

In some implementations, the SA type indicator may be a list of ENUMERATED formats, allowing it to take one of three possible values: {′SUBSEQUENT_CHO′, ‘SUBSEQUENT_CPAC’, ‘FALSE’}.

In some implementations, the SA type indicator may include two lists of prepared CHO-with-CPAC configuration IDs. One list may indicate the CHO-with-CPAC configurations to be used for a subsequent CHO with a CPAC; the other list may indicate the CHO-with-CPAC configurations to be used for CHO with subsequent CPAC. It should be noted that the ID is (only) known and common to the candidate target MN and the source node (e.g., the source MN).

In some implementations, the CHO-with-CPAC configuration IDs in the lists may be sorted in an ascending order. For example, the first entry of the first list may indicate the CHO-with-CPAC configuration with the lowest conditional configuration ID among the CHO-with-CPAC configurations which are to be used for a subsequent CHO with a CPAC. For example, the first entry of the second list may indicate the CHO-with-CPAC configuration with the lowest conditional configuration ID among the CHO-with-CPAC configurations which are to be used for a CHO with a subsequent CPAC.

In some implementations, the CHO-with-CPAC configuration IDs in the lists may be sorted in a descending order. For example, the first entry of the first list may indicate the CHO-with-CPAC configuration with the highest conditional configuration ID among the CHO-with-CPAC configurations which are to be used for a subsequent CHO with a CPAC. For example, the first entry of the second list may indicate the CHO-with-CPAC configuration with the highest conditional configuration ID among the CHO-with-CPAC configurations which are to be used for CHO with subsequent CPAC.

In some implementations, the SA type indicator may include three lists of prepared CHO-with-CPAC configuration IDs. One list may indicate the CHO-with-CPAC configurations to be used for a subsequent CHO with a CPAC; another list may indicate the CHO-with-CPAC configurations to be used for CHO with subsequent CPAC; the other list may indicate the CHO-with-CPAC configurations to be released after an execution of a conditional configuration.

In some implementations, the CHO-with-CPAC configuration IDs in the lists may be sorted in an ascending order. For example, the first entry of the first list may indicate the CHO-with-CPAC configuration with the lowest conditional configuration ID among the CHO-with-CPAC configurations which are to be used for a subsequent CHO with a CPAC. For example, the first entry of the second list may indicate the CHO-with-CPAC configuration with the lowest conditional configuration ID among the CHO-with-CPAC configurations which are to be used for CHO with subsequent CPAC. For example, the first entry of the third list may indicate the CHO-with-CPAC configuration with the lowest conditional configuration ID among the CHO-with-CPAC configurations which are to be released.

In some implementations, the CHO-with-CPAC configuration IDs in the lists may be sorted in a descending order. For example, the first entry of the first list may indicate the CHO-with-CPAC configuration with the highest conditional configuration ID among the CHO-with-CPAC configurations which are to be used for a subsequent CHO with a CPAC. For example, the first entry of the second list may indicate the CHO-with-CPAC configuration with the highest conditional configuration ID among the CHO-with-CPAC configurations which are to be used for CHO with a subsequent CPAC. For example, the first entry of the third list may indicate the CHO-with-CPAC configuration with the highest conditional configuration ID among the CHO-with-CPAC configurations which are to be released.

In some implementations, upon receiving the Message 4, the source node (e.g., the source MN) may determine the selective activation types of the CHO-with-CPAC configurations.

In some implementations, if there is no SA type indicator in the Message 4, the source node (e.g., the source MN) may determine the selective activation type of each CHO-with-CPAC configuration received from the candidate target MN to be a default ENUMERATED value.

In some implementations, the default ENUMERATED value may be ‘SUBSEQUENT_CHO’.

In some implementations, the default ENUMERATED value may be ‘SUBSEQUENT_CPAC’.

In some implementations, the default ENUMERATED value may be set to ‘FALSE’.

In some implementations, if there is no SA type indicator in the Message 4, the source node (e.g., the source MN) may determine the selective activation type of each CHO-with-CPAC configuration received from the candidate target MN according to some criteria (e.g., such as the measurement results of the corresponding PCell and PSCell, the radio configuration of the corresponding MCG and SCG, the CPAC execution condition for the PSCell, etc.).

In some implementations, if the SA type indicator in the Message 4 has a single ENUMERATED format, the source node (e.g., the source MN) may set the selective activation type of all the CHO-with-CPAC configurations received from the candidate target MN to the value of the SA type indicator.

In some implementations, if the SA type indicator is set to ‘SUBSEQUENT_CHO’, the source node may set the selective activation type of all the CHO-with-CPAC configurations received from the candidate target MN to ‘SUBSEQUENT_CHO’.

In some implementations, if the SA type indicator is set to ‘SUBSEQUENT_CPAC’, the source node may set the selective activation type of all the CHO-with-CPAC configurations received from the candidate target MN to ‘SUBSEQUENT_CPAC’.

In some implementations, if the SA type indicator is ‘FALSE’, the source node may set the selective activation type of all the CHO-with-CPAC configurations received from the candidate target MN to ‘FALSE’.

In some implementations, if the SA type indicator is a list of ENUMERATED formats, the source node (e.g., the source MN) may set the selective activation type of each CHO-with-CPAC configuration according to the corresponding ENUMERATED value.

In some implementations, if the ENUMERATED value corresponding to a CHO-with-CPAC configuration is ‘SUBSEQUENT_CHO’, the source node may set the selective activation type of the CHO-with-CPAC configuration to ‘SUBSEQUENT_CHO’.

In some implementations, if the ENUMERATED value corresponding to a CHO-with-CPAC configuration is ‘SUBSEQUENT_CPAC’, the source node may set the selective activation type of the CHO-with-CPAC configuration to ‘SUBSEQUENT_CPAC’.

In some implementations, if the ENUMERATED value corresponding to a CHO-with-CPAC configuration is ‘FALSE’, the source node may set the selective activation type of the CHO-with-CPAC configuration to ‘FALSE’.

In some implementations, if the SA type indicator includes two lists of prepared CHO-with-CPAC configuration IDs, the source node (e.g., the source MN) may set the selective activation type of the CHO-with-CPAC configurations according to their IDs included in the lists.

In some implementations, if the ID of a CHO-with-CPAC configuration is included in the first list, the source node may set the selective activation type of CHO-with-CPAC configuration to ‘SUBSEQUENT_CHO’; if the ID of a CHO-with-CPAC configuration is included in the second list, the source node may set the selective activation type of the CHO-with-CPAC configuration to ‘SUBSEQUENT_CPAC’; if the ID of a CHO-with-CPAC configuration is included in neither of the lists, the source node may set the selective activation type of the CHO-with-CPAC configuration to ‘FALSE’.

In some implementations, if the ID of a CHO-with-CPAC configuration is included in the first list, the source node may set the selective activation type of CHO-with-CPAC configuration to ‘SUBSEQUENT_CPAC’; if the ID of a CHO-with-CPAC configuration is included in the second list, the source node may set the selective activation type of the CHO-with-CPAC configuration to ‘SUBSEQUENT_CHO’; if the ID of a CHO-with-CPAC configuration is included in neither of the lists, the source node may set the selective activation type of the CHO-with-CPAC configuration to ‘FALSE’.

In some implementations, if the SA type indicator includes three lists of prepared CHO-with-CPAC configuration IDs, the source node (e.g., the source MN) may set the selective activation type of the CHO-with-CPAC configurations according to their IDs included in the lists.

In some implementations, if the ID of a CHO-with-CPAC configuration is included in the first list, the source node may set the selective activation type of CHO-with-CPAC configuration to ‘SUBSEQUENT_CHO’; if the ID of a CHO-with-CPAC configuration is included in the second list, the source node may set the selective activation type of the CHO-with-CPAC configuration to ‘SUBSEQUENT_CPAC’; if the ID of a CHO-with-CPAC configuration is included in neither of the lists, the source node may set the selective activation type of the CHO-with-CPAC configuration to ‘FALSE’.

In some implementations, if the ID of a CHO-with-CPAC configuration is included in the first list, the source node may set the selective activation type of CHO-with-CPAC configuration to ‘SUBSEQUENT_CHO’; if the ID of a CHO-with-CPAC configuration is included in the second list, the source node may set the selective activation type of the CHO-with-CPAC configuration to ‘FALSE’; if the ID of a CHO-with-CPAC configuration is included in neither of the lists, the source node may set the selective activation type of the CHO-with-CPAC configuration to ‘SUBSEQUENT_CPAC’.

In some implementations, if the ID of a CHO-with-CPAC configuration is included in the first list, the source node may set the selective activation type of CHO-with-CPAC configuration to ‘SUBSEQUENT_CPAC’; if the ID of a CHO-with-CPAC configuration is included in the second list, the source node may set the selective activation type of the CHO-with-CPAC configuration to ‘SUBSEQUENT_CHO’; if the ID of a CHO-with-CPAC configuration is included in neither of the lists, the source node may set the selective activation type of the CHO-with-CPAC configuration to ‘FALSE’.

In some implementations, if the ID of a CHO-with-CPAC configuration is included in the first list, the source node may set the selective activation type of CHO-with-CPAC configuration to ‘SUBSEQUENT_CPAC’; if the ID of a CHO-with-CPAC configuration is included in the second list, the source node may set the selective activation type of the CHO-with-CPAC configuration to ‘FALSE’; if the ID of a CHO-with-CPAC configuration is included in neither of the lists, the source node may set the selective activation type of the CHO-with-CPAC configuration to ‘SUBSEQUENT_CHO’.

In some implementations, if the ID of a CHO-with-CPAC configuration is included in the first list, the source node may set the selective activation type of CHO-with-CPAC configuration to ‘FALSE’; if the ID of a CHO-with-CPAC configuration is included in the second list, the source node may set the selective activation type of the CHO-with-CPAC configuration to ‘SUBSEQUENT_CHO’; if the ID of a CHO-with-CPAC configuration is included in neither of the lists, the source node may set the selective activation type of the CHO-with-CPAC configuration to ‘SUBSEQUENT_CPAC’.

In some implementations, if the ID of a CHO-with-CPAC configuration is included in the first list, the source node may set the selective activation type of CHO-with-CPAC configuration to ‘FALSE’; if the ID of a CHO-with-CPAC configuration is included in the second list, the source node may set the selective activation type of the CHO-with-CPAC configuration to ‘SUBSEQUENT_CPAC’; if the ID of a CHO-with-CPAC configuration is included in neither of the lists, the source node may set the selective activation type of the CHO-with-CPAC configuration to ‘SUBSEQUENT_CHO’.

### Additional IE in Existing CHO-with-CPAC Configuration

In some implementations, upon receiving the messages from all the candidate target MNs, the source node (e.g., the source MN) may transmit the conditional configurations to the UE via RRC signaling. In the present disclosure, the term “conditional configuration” may be referred to as a CHO-only configuration, a CHO-with-SCG configuration, a CHO-with-CPAC configuration, a CHO-with-subsequent-CPAC configuration, a subsequent CHO-with-CPAC configuration, and/or a conditional configuration in the above five types of configurations.

In some implementations, a CHO-only configuration may include a configuration or an IE that includes/indicates the candidate target PCell(s), the execution condition(s) for the candidate target PCell(s), and/or the MCG configuration for the candidate target PCell(s). It should be noted that the CHO-only configuration does not include any execution conditions for any PSCell, nor does it include any SCG configuration for any PSCell.

In some implementations, a CHO-with-SCG configuration may include a configuration or an IE that includes/indicates the candidate target PCell(s), the associated PSCell(s) (e.g., the PSCell(s) associated with the candidate target PCell(s)), the execution condition(s) for the candidate target PCell(s), the MCG configuration for the candidate target PCell(s), and/or the SCG configuration for the associated PSCell(s). It should be noted that the CHO-with-SCG configuration does not include any execution condition for any PSCell. Additionally, in a CHO-with-SCG configuration, a PSCell is considered associated with a (candidate target) PCell if the cell ID (e.g., physical cell ID) of the PSCell is present in the CHO-with-SCG configuration that contains the cell ID of the (candidate target) PCell.

In some implementations, the source node may transmit RRC signaling to the UE. The RRC signaling may include multiple CHO-only configurations, and/or CHO-with-SCG configurations, and/or CHO-with-CPAC configurations.

In some implementations, a CHO-with-CPAC configuration may include the execution condition(s) for the candidate target PCell, the execution condition(s) for the candidate target PSCell, and the MCG and SCG configurations.

In some implementations, a CHO-with-CPAC configuration may additionally include an IE indicating that the CHO-with-CPAC configuration may be kept for the selective activation of the MCG and the SCG. The SA type indicator may include the IE indicating whether a single CHO-with-CPAC configuration is kept for the selective activation of the MCG and the SCG. In some implementations, when generating the RRC message, the source node (e.g., the source MN) may set the SA type indicator of the CHO-with-CPAC configuration in the RRC signaling according to the stored selective activation type of the CHO-with-CPAC configuration.

In some implementations, if the stored selective activation type of the CHO-with-CPAC configuration is ‘SUBSEQUENT_CHO’, the source node (e.g., the source MN) may set the SA type indicator included in the CHO-with-CPAC to configuration ‘SUBSEQUENT_CHO’ while generating the RRC message.

In some implementations, if the stored selective activation type of the CHO-with-CPAC configuration is ‘SUBSEQUENT_CPAC’, the source node (e.g., the source MN) may set the SA type indicator included in the CHO-with-CPAC configuration to ‘SUBSEQUENT_CPAC’ while generating the RRC message.

In some implementations, if the stored selective activation type of the CHO-with-CPAC configuration is ‘FALSE’, the source node (e.g., the source MN) may set the SA type indicator included in the CHO-with-CPAC configuration to ‘FALSE’ while generating the RRC message.

In some implementations, the SA type indicator may have a 1-bit value, where the value=1 refers ‘SUBSEQUENT_CHO’ and the value=0 refers “SUBSEQUENT_CPAC’. If the SA type indicator is absent, the UE may assume CHO configuration may be executed according to a legacy behavior.

In some implementations, an additional IE, different from the CHO-with-CPAC configuration, may be configured to the UE to indicate to the UE whether each CHO-with-CPAC configuration should be kept for the selective activation of the MCG and the SCG. The SA type indicator list may include the IE indicating whether multiple CHOs with CPAC configurations should be kept for the selective activation of the MCG and the SCG. In some implementations, when generating the RRC message, the source node (e.g., the source MN) may set the SA type indicator list in the RRC signaling according to the stored selective activation types of the CHO-with-CPAC configurations.

In some implementations, the SA type indicator list may include two lists, each of which may include one or more conditional configuration IDs.

In some implementations, the source node (e.g., the source MN) may include the conditional configuration IDs of a CHO-with-CPAC configuration in the first list if the selective activation type of the CHO-with-CPAC configuration is ‘SUBSEQUENT_CHO’; the source node (e.g., the source MN) may include the conditional configuration IDs of a CHO-with-CPAC configuration in the second list if the selective activation type of the CHO-with-CPAC configuration is ‘SUBSEQUENT_CPAC’.

In some implementations, the source node (e.g., the source MN) may include the conditional configuration IDs of a CHO-with-CPAC configuration in the first list if the selective activation type of the CHO-with-CPAC configuration is ‘SUBSEQUENT_CPAC’; the source node (e.g., the source MN) may include the conditional configuration IDs of a CHO-with-CPAC configuration in the second list if the selective activation type of the CHO-with-CPAC configuration is ‘SUBSEQUENT_CHO’.

In some implementations, the first list and the second list may be configured by the order of the CHO and the CPAC configurations. Specifically, if the CHO is configured prior to the CPAC configuration, then the first list may be associated with ‘SUBSEQUENT_CHO’, otherwise the first list may be associated with ‘SUBSEQUENT_CPAC’.

In some implementations, if the conditional configuration ID doesn't appear in any of the first list and the second list, the UE may assume the corresponding configuration to be applied based on a legacy behavior.

In some implementations, the conditional configuration IDs in the lists may be sorted in an ascending order. For example, the first entry of the first list may indicate the CHO-with-CPAC configuration with the lowest conditional configuration ID among the CHO-with-CPAC configurations the selective activation type of which is ‘SUBSEQUENT_CHO’. For example, the first entry of the second list may indicate the CHO-with-CPAC configuration with the lowest conditional configuration ID among the CHO-with-CPAC configurations the selective activation type of which is ‘SUBSEQUENT_CPAC’.

In some implementations, the conditional configuration IDs in the lists may be sorted in a descending order. For example, the first entry of the first list may indicate the CHO-with-CPAC configuration with the highest conditional configuration ID among the CHO-with-CPAC configurations the selective activation type of which is ‘SUBSEQUENT_CHO’. For example, the first entry of the second list may indicate the CHO-with-CPAC configuration with the highest conditional configuration ID among the CHO-with-CPAC configurations the selective activation type of which is ‘SUBSEQUENT_CPAC’.

In some implementations, the SA type indicator list may include three lists, each of which may include one or more conditional configuration IDs.

In some implementations, the source node (e.g., the source MN) may include the conditional configuration ID of a CHO-with-CPAC configuration in the first list if the selective activation type of the CHO-with-CPAC configuration is ‘SUBSEQUENT_CHO’; the source node (e.g., the source MN) may include the conditional configuration ID of a CHO-with-CPAC configuration in the second list if the selective activation type of the CHO-with-CPAC configuration is ‘SUBSEQUENT_CPAC’; the source node (e.g., the source MN) may include the conditional configuration ID of a CHO-with-CPAC configuration in the third list if the selective activation type of the CHO-with-CPAC configuration is ‘FALSE’.

In some implementations, the source node (e.g., the source MN) may include the conditional configuration ID of a CHO-with-CPAC configuration in the first list if the selective activation type of the CHO-with-CPAC configuration is ‘SUBSEQUENT_CHO’; the source node (e.g., the source MN) may include the conditional configuration ID of a CHO-with-CPAC configuration in the second list if the selective activation type of the CHO-with-CPAC configuration is ‘FALSE’; the source node (e.g., the source MN) may include the conditional configuration ID of a CHO-with-CPAC configuration in the third list if the selective activation type of the CHO-with-CPAC configuration is ‘SUBSEQUENT_CPAC’.

In some implementations, the source node (e.g., the source MN) may include the conditional configuration ID of a CHO-with-CPAC configuration in the first list if the selective activation type of the CHO-with-CPAC configuration is ‘SUBSEQUENT_CPAC’; the source node (e.g., the source MN) may include the conditional configuration ID of a CHO-with-CPAC configuration in the second list if the selective activation type of the CHO-with-CPAC configuration is ‘SUBSEQUENT_CHO; the source node (e.g., the source MN) may include the conditional configuration ID of a CHO-with-CPAC configuration in the third list if the selective activation type of the CHO-with-CPAC configuration is ‘FALSE’.

In some implementations, the source node (e.g., the source MN) may include the conditional configuration ID of a CHO-with-CPAC configuration in the first list if the selective activation type of the CHO-with-CPAC configuration is ‘SUBSEQUENT_CPAC’; the source node (e.g., the source MN) may include the conditional configuration ID of a CHO-with-CPAC configuration in the second list if the selective activation type of the CHO-with-CPAC configuration is ‘FALSE’; the source node (e.g., the source MN) may include the conditional configuration ID of a CHO-with-CPAC configuration in the third list if the selective activation type of the CHO-with-CPAC configuration is ‘SUBSEQUENT_CHO’.

In some implementations, the source node (e.g., the source MN) may include the conditional configuration ID of a CHO-with-CPAC configuration in the first list if the selective activation type of the CHO-with-CPAC configuration is ‘FALSE’; the source node (e.g., the source MN) may include the conditional configuration ID of a CHO-with-CPAC configuration in the second list if the selective activation type of the CHO-with-CPAC configuration is ‘SUBSEQUENT_CHO’; the source node (e.g., the source MN) may include the conditional configuration ID of a CHO-with-CPAC configuration in the third list if the selective activation type of the CHO-with-CPAC configuration is ‘SUBSEQUENT_CPAC’.

In some implementations, the source node (e.g., the source MN) may include the conditional configuration ID of a CHO-with-CPAC configuration in the first list if the selective activation type of the CHO-with-CPAC configuration is ‘FALSE’; the source node (e.g., the source MN) may include the conditional configuration ID of a CHO-with-CPAC configuration in the second list if the selective activation type of the CHO-with-CPAC configuration is ‘SUBSEQUENT_CPAC’; the source node (e.g., the source MN) may include the conditional configuration ID of a CHO-with-CPAC configuration in the third list if the selective activation type of the CHO-with-CPAC configuration is ‘SUBSEQUENT_CHO’.

In some implementations, the conditional configuration IDs in the lists may be sorted in an ascending order. In some implementations, the first entry of the first list may indicate the CHO-with-CPAC configuration with the lowest conditional configuration ID among the CHO-with-CPAC configurations the selective activation type of which is ‘SUBSEQUENT_CHO’. For example, the first entry of the second list may indicate the CHO-with-CPAC configuration with the lowest conditional configuration ID among the CHO-with-CPAC configurations the selective activation type of which is ‘SUBSEQUENT_CPAC’. For example, the first entry of the third list may indicate the CHO-with-CPAC configuration with the lowest conditional configuration ID among the CHO-with-CPAC configurations the selective activation type of which is ‘FALSE’.

In some implementations, the conditional configuration IDs in the lists may be sorted in a descending order. For example, the first entry of the first list may indicate the CHO-with-CPAC configuration with the highest conditional configuration ID among the CHO-with-CPAC configurations the selective activation type of which is ‘SUBSEQUENT_CHO’. For example, the first entry of the second list may indicate the CHO-with-CPAC configuration with the highest conditional configuration ID among the CHO-with-CPAC configurations the selective activation type of which is ‘SUBSEQUENT_CPAC’. For example, the first entry of the third list may indicate the CHO-with-CPAC configuration with the highest conditional configuration ID among the CHO-with-CPAC configurations the selective activation type of which is ‘FALSE’.

In some implementations, the source node (e.g., the source MN) may transmit the SA type indicator list to the UE before the transmission of CHO-with-CPAC configurations to the UE. For example, the SA type indicator list may be included in an RRC message transmitted to the UE other than another RRC message including the CHO-with-CPAC configurations transmitted to the UE.

In some implementations, the source node (e.g., the source MN) may transmit the SA type indicator list to the UE along with the CHO-with-CPAC configurations in the same RRC message.

In some implementations, after the UE transitions to the RRC_inactive state, the SA type indicator list and the corresponding configuration may be released. In some implementations, after the UE transitions to the RRC_inactive state, the SA type indicator list and the corresponding configuration may be suspended and may be resumed after UE enters the RRC_connected state and the camped cell is the same source node; otherwise, even if the UE enters the RRC_connected state, the configuration may keep suspended.

In some implementations, the source node (e.g., the source MN) may transmit the SA type indicator list to the UE after the transmission of CHO-with-CPAC configurations to the UE. In some implementations, in this case, the source node (e.g., the source MN) may include an additional IE, which may be included in the same RRC message including the CHO-with-CPAC configuration, to indicate that the SA type indicator list is transmitted after the CHO-with-CPAC configuration.

In some implementations, the additional IE may utilize an ENUMERATED format and take a value: ‘TRUE’.

In some implementations, if the additional IE is present, the UE may be configured to store and apply the received CHO-with-CPAC configurations after receiving the SA type indicator list.

In some implementations, if the additional IE is absent, the UE may be configured to store and apply the received CHO-with-CPAC configurations upon receiving the RRC message including the CHO-with-CPAC configurations.

In some implementations, if a UE receives the SA type indicator list before receiving the RRC message including the CHO-with-CPAC configurations, the UE may store the SA type indicator list. In some implementations, upon receiving the CHO-with-CPAC configurations, for each CHO-with-CPAC configuration, the UE may set the corresponding SA type indicator according to the stored SA type indicator list. In some implementations, after setting the SA type indicator of a CHO-with-CPAC configuration, the UE may include the SA type indicator in the CHO-with-CPAC configuration and store the CHO-with-CPAC configuration. It should be noted that the UE may not include the SA type indicator in the CHO-with-CPAC configuration if the SA type indicator is ‘FALSE’. The UE may ignore (or discard) the SA type indicator in the CHO-with-CPAC configuration if the SA type indicator is ‘FALSE’.

In some implementations, if a UE receives the CHO-with-CPAC configurations and the SA type indicator list in the same RRC message, the UE may store both the CHO-with-CPAC configurations and the SA type indicator list.

In some implementations, if a UE receives the CHO-with-CPAC configurations and the SA type indicator list in the same RRC message, the UE may set the SA type indicator of each CHO-with-CPAC configuration according to the received SA type indicator list. In some implementations, after setting the SA type indicator of a CHO-with-CPAC configuration, the UE may include the SA type indicator in the CHO-with-CPAC configuration and store the CHO-with-CPAC configuration. It should be noted that the UE may not include the SA type indicator in the CHO-with-CPAC configuration if the SA type indicator is ‘FALSE’. The UE may ignore (or discard) the SA type indicator in the CHO-with-CPAC configuration if the SA type indicator is ‘FALSE’.

In some implementations, if a UE receives the CHO-with-CPAC configurations and the SA type indicator list in the same RRC message, the UE may set the SA type indicator of each CHO-with-CPAC configuration according to the received SA type indicator list. In some implementations, after setting the SA type indicator of a CHO-with-CPAC configuration, the UE may include the SA type indicator with the value corresponding to the entry in the SA type indicator list in the CHO-with-CPAC configuration. In some implementations, the UE may then store the CHO-with-CPAC configuration, It should be noted that the UE may not include the SA type indicator in the CHO-with-CPAC configuration if the SA type indicator is ‘FALSE’. The UE may ignore (or discard) the SA type indicator in the CHO-with-CPAC configuration if the SA type indicator is ‘FALSE’.

In some implementations, if a UE receives the CHO-with-CPAC configurations with an indication IE indicating that the SA type indicator list may be transmitted later, the UE may store the CHO-with-CPAC configurations.

In some implementations, upon receiving the SA type indicator list, the UE may store the indicator list.

In some implementations, upon receiving the SA type indicator list, the UE may set the corresponding SA type indicator according to the SA type indicator list. In some implementations, the UE may include each SA type indicator in the corresponding CHO-with-CPAC configuration and store the CHO-with-CPAC configurations. It should be noted that the UE may not include the SA type indicator in the CHO-with-CPAC configuration if the SA type indicator is ‘FALSE’.

In some implementations, if a UE receives the CHO-with-CPAC configurations without an indication IE which indicates that the SA type indicator list may be transmitted later, the UE may store the CHO-with-CPAC configuration. In some implementations, if a UE receives the CHO-with-CPAC configurations without an indication IE which indicates the SA type indication list may be transmitted later, the UE may set the corresponding SA type indicator autonomously (e.g., by itself). For example, the UE may set the SA type indicator of all the received CHO-with-CPAC configurations to be ‘FALSE’, and then the UE may or may not include them in the corresponding CHO-with-CPAC configurations, and the UE store the CHO-with-CPAC configurations.

In some implementations, if a UE receives the CHO-with-CPAC configurations with an indication IE which indicates that the SA type indicator list may be transmitted later, the UE may store the CHO-with-CPAC configurations and wait for the configuration of SA type indicator list. In some implementation, upon receiving the SA type indicator list, the UE may set the SA type indicator of the stored CHO-with-CPAC configurations according to the SA type indicator list.

In some implementations, upon setting the SA type indicator of the received CHO-with-CPAC configurations according to the SA type indicator list, if the SA type indicator list includes two lists of conditional configuration IDs, the UE may set the SA type indicator of each CHO-with-CPAC configuration according to its conditional configuration ID and the SA type indicator list.

In some implementations, if a CHO-with-CPAC configuration the conditional configuration ID of which is included in the first list, the UE may set the SA type indicator of the CHO-with-CPAC configuration to ‘SUBSEQUENT_CHO’; if a CHO-with-CPAC configuration the conditional configuration ID of which is included in the second list, the UE may set the SA type indicator of the CHO-with-CPAC configuration to ‘SUBSEQUENT_CPAC’; if a CHO-with-CPAC configuration the conditional configuration ID of which is included in neither of the lists, the UE may set the SA type indicator of the CHO-with-CPAC configuration to ‘FALSE’.

In some implementations, if a CHO-with-CPAC configuration the conditional configuration ID of which is included in the first list, the UE may set the SA type indicator of the CHO-with-CPAC configuration to ‘SUBSEQUENT_CPAC’; if a CHO-with-CPAC configuration the conditional configuration ID of which is included in the second list, the UE may set the SA type indicator of the CHO-with-CPAC configuration to ‘SUBSEQUENT_CHO’; if a CHO-with-CPAC configuration the conditional configuration ID of which is included in neither of the lists, the UE may set the SA type indicator of the CHO-with-CPAC configuration to ‘FALSE’.

In some implementations, upon setting the SA type indicator of the received CHO-with-CPAC configurations according to the SA type indicator list, if the SA type indicator list includes three lists of conditional configuration IDs, the UE may set the SA type indicator of each CHO-with-CPAC configuration according to its conditional configuration ID and the SA type indicator list.

In some implementations, if a CHO-with-CPAC configuration the conditional configuration ID of which is included in the first list, the UE may set the SA type indicator of the CHO-with-CPAC configuration to ‘SUBSEQUENT_CHO’; if a CHO-with-CPAC configuration the conditional configuration ID of which is included in the second list, the UE may set the SA type indicator of the CHO-with-CPAC configuration to ‘SUBSEQUENT_CPAC’; if a CHO-with-CPAC configuration the conditional configuration ID of which is included in the third list, the UE may set the SA type indicator of the CHO-with-CPAC configuration to ‘FALSE’.

In some implementations, if a CHO-with-CPAC configuration the conditional configuration ID of which is included in the first list, the UE may set the SA type indicator of the CHO-with-CPAC configuration to ‘SUBSEQUENT_CHO’; if a CHO-with-CPAC configuration the conditional configuration ID of which is included in the second list, the UE may set the SA type indicator of the CHO-with-CPAC configuration to ‘FALSE’; if a CHO-with-CPAC configuration the conditional configuration ID of which is included in the third list, the UE may set the SA type indicator of the CHO-with-CPAC configuration to ‘SUBSEQUENT_CPAC’.

In some implementations, if a CHO-with-CPAC configuration the conditional configuration ID of which is included in the first list, the UE may set the SA type indicator of the CHO-with-CPAC configuration to ‘SUBSEQUENT_CPAC’; if a CHO-with-CPAC configuration the conditional configuration ID of which is included in the second list, the UE may set the SA type indicator of the CHO-with-CPAC configuration to ‘SUBSEQUENT_CHO’; if a CHO-with-CPAC configuration the conditional configuration ID of which is included in the third list, the UE may set the SA type indicator of the CHO-with-CPAC configuration to ‘FALSE’.

In some implementations, if a CHO-with-CPAC configuration the conditional configuration ID of which is included in the first list, the UE may set the SA type indicator of the CHO-with-CPAC configuration to ‘SUBSEQUENT_CPAC’; if a CHO-with-CPAC configuration the conditional configuration ID of which is included in the second list, the UE may set the SA type indicator of the CHO-with-CPAC configuration to ‘FALSE’; if a CHO-with-CPAC configuration the conditional configuration ID of which is included in the third list, the UE may set the SA type indicator of the CHO-with-CPAC configuration to ‘SUBSEQUENT_CHO’.

In some implementations, if a CHO-with-CPAC configuration the conditional configuration ID of which is included in the first list, the UE may set the SA type indicator of the CHO-with-CPAC configuration to ‘FALSE’; if a CHO-with-CPAC configuration the conditional configuration ID of which is included in the second list, the UE may set the SA type indicator of the CHO-with-CPAC configuration to ‘SUBSEQUENT_CHO’; if a CHO-with-CPAC configuration the conditional configuration ID of which is included in the third list, the UE may set the SA type indicator of the CHO-with-CPAC configuration to ‘SUBSEQUENT_CPAC’.

In some implementations, if a CHO-with-CPAC configuration the conditional configuration ID of which is included in the first list, the UE may set the SA type indicator of the CHO-with-CPAC configuration to ‘FALSE’; if a CHO-with-CPAC configuration the conditional configuration ID of which is included in the second list, the UE may set the SA type indicator of the CHO-with-CPAC configuration to ‘SUBSEQUENT_CPAC’; if a CHO-with-CPAC configuration the conditional configuration ID of which is included in the third list, the UE may set the SA type indicator of the CHO-with-CPAC configuration to ‘SUBSEQUENT_CHO’.

In some implementations, if a CHO-with-CPAC configuration the conditional configuration ID of which is included in none of the lists, the UE may set the SA type indicator of the CHO-with-CPAC configuration to ‘FALSE’.

In some implementations, upon setting the SA type indicator of the received CHO-with-CPAC configurations according to the SA type indicator list, if the SA type indicator list includes a list of ENUMERATED variables, the UE may set the SA type indicator of each CHO-with-CPAC configuration according to the list.

In some implementations, if a CHO-with-CPAC configuration for which the corresponding ENUMERATED variable is ‘SUBSEQUENT_CHO’, the UE may set the SA type indicator of the CHO-with-CPAC configuration to ‘SUBSEQUENT_CHO’; if a CHO-with-CPAC configuration for which the corresponding ENUMERATED variable is ‘SUBSEQUENT_CPAC’, the UE may set the SA type indicator of the CHO-with-CPAC configuration to ‘SUBSEQUENT_CPAC’; if a CHO-with-CPAC configuration for which the corresponding ENUMERATED variable is ‘FALSE’, the UE may set the SA type indicator of the CHO-with-CPAC configuration to ‘FALSE’.

In some implementations, if there is no ENUMERATED variable corresponding to a CHO-with-CPAC configuration, the UE may set the SA type indicator of the CHO-with-CPAC configuration to ‘FALSE’.

In some implementations, after the UE finishes determining the SA type indicator of all the CHO-with-CPAC configurations, the UE may release the stored SA type indicator list.

In some implementations, during the evaluation of execution condition(s), if there is one or more conditional configurations the execution condition(s) of which is/are considered to be satisfied by the UE, the UE may select and apply the conditional configuration (or one of the conditional configurations). In some implementations, during the evaluation of execution condition(s), if there is one or more conditional configurations the execution condition(s) of which is/are considered to be satisfied by the UE, the UE may select the conditional configuration with the lowest (or highest) ID among the one or more conditional configurations the execution condition(s) of which is/are considered to be satisfied. In the present disclosure, the terminology “satisfied conditional configuration” may be used to represent such a conditional configuration. It should be noted that an execution condition may be considered to be satisfied if the configured measurement event (e.g., the RSRP value of the target cell is higher than a threshold (e.g., RRC configured RSRP value)) remains the same for a configured time-to-trigger duration.

In some implementations, if a CHO-with-SCG configuration or a CHO-with-CPAC configuration is selected by the UE, the UE may perform a random access procedure with the PCell associated with the selected conditional configuration. If the random access procedure is successful (e.g., a monitoring timer does not expire before the UE completes the random access procedure), the UE may start to perform the random access procedure with the PSCell associated with the selected conditional configuration. If the random access procedure is successful (e.g., a monitoring timer does not expire before the UE completes the random access procedure), the UE may complete the connection with both the new PCell and the new PSCell, and the UE may continue the data transmission to and/or reception from the cells configured in the new MCG and SCG configuration.

In some implementations, the UE may keep and/or release some of the stored conditional configurations upon completing the random access procedure with the new PCell.

In some implementations, the UE may release all the stored CHO-only configurations and all the stored CHO-with-SCG configurations.

In some implementations, the UE may release the stored CHO-with-CPAC configurations the SA type indicators of which are set to ‘SUBSEQUENT_CPAC’ and which are not associated with the new PCell.

In some implementations, the UE may release the stored CHO-with-CPAC configurations without an SA type indicator.

In some implementations, the UE may release the stored CHO-with-CPAC configurations with an SA type indicator which is set to ‘FALSE’.

In some implementations, the UE may keep the stored CHO-with-CPAC configurations with an SA type indicator which is set to ‘SUBSEQUENT_CHO’ or ‘SUBSEQUENT_CPAC’.

In some implementations, the UE may keep the stored CHO-with-CPAC configurations which is associated with the new PCell and with an SA type indicator which is set to ‘SUBSEQUENT_CPAC’.

In some implementations, the UE may check the stored SA type indicator list.

In some implementations, if the SA type indicator list includes two lists of conditional configuration IDs, the UE may release/keep the stored CHO-with-CPAC configurations according to the lists.

In some implementations, the UE may release the stored CHO-with-CPAC configurations the conditional configuration IDs of which are included in neither of the lists.

In some implementations, the UE may keep the stored CHO-with-CPAC configurations the conditional configuration IDs of which are included in one of the lists.

In some implementations, the UE may keep the stored CHO-with-CPAC configurations the conditional configuration IDs of which are included in one of the lists and which are associated with the new PCell.

In some implementations, the UE may release the stored CHO-with-CPAC configurations the conditional configuration IDs of which are included in one of the lists and which are not associated with the new PCell.

In some implementations, if the SA type indicator list includes three lists of conditional configuration IDs, the UE may release the stored CHO-with-CPAC configurations according to the lists.

In some implementations, the UE may keep/release the stored CHO-with-CPAC configurations the conditional configuration IDs of which are included in one of the lists.

In some implementations, the UE may keep the stored CHO-with-CPAC configurations the conditional configuration IDs of which are included in one of the lists and which are associated with the new PCell.

In some implementations, the UE may release the stored CHO-with-CPAC configurations the conditional configuration IDs of which are included in one of the lists and which are associated with the new PCell.

In some implementations, if the SA type indicator list includes ENUMERATED formats, the UE may keep/release the stored CHO-with-CPAC configurations according to the list of ENUMERATED values.

In some implementations, the UE may release the stored CHO-with-CPAC configurations for which the corresponding ENUMERATED values are ‘FALSE’.

In some implementations, the UE may release the stored CHO-with-CPAC configurations for which the corresponding ENUMERATED values are ‘SUBSEQUENT_CPAC’ and which are not associated with the new PCell.

In some implementations, the UE may keep the stored CHO-with-CPAC configurations for which the corresponding ENUMERATED values are ‘SUBSEQUENT_CHO’.

In some implementations, the UE may keep the stored CHO-with-CPAC configurations for which the corresponding ENUMERATED values are ‘SUBSEQUENT_CPAC’ and which are associated with the new PCell.

In some implementations, the UE may keep all the stored conditional configurations (e.g., the CHO-only, the CHO with SCG, and the CHO with CPC configurations) after it completes the random access procedure with the new PCell.

In some implementations, the UE may keep/release some of the stored conditional configurations upon completing the random access procedure with the new PSCell.

In some implementations, the UE may release all the stored CHO-only configurations and all the CHO-with-SCG configurations.

In some implementations, the UE may release the stored CHO-with-CPAC configurations without an SA type indicator.

In some implementations, the UE may release the stored CHO-with-CPAC configurations the SA type indicator of which is ‘FALSE’.

In some implementations, the UE may release the stored CHO-with-CPAC configurations the SA type indicator of which is ‘SUBSEQUENT_CPAC’.

In some implementations, the UE may release the stored CHO-with-CPAC configurations the SA type indicators of which are ‘SUBSEQUENT_CPAC’ and which are not associated with the new PCell.

In some implementations, the UE may keep the stored CHO-with-CPAC configurations the SA type indicators of which are ‘SUBSEQUENT_CHO’.

In some implementations, the UE may keep the stored CHO-with-CPAC configurations the SA type indicators of which are ‘SUBSEQUENT_CPAC’ and which are associated with the new PCell.

In some implementations, the UE may check the stored SA type indicator list when deciding which CHO-with-CPAC configuration to be released.

In some implementations, if the SA type indicator list includes two lists of conditional configuration IDs, the UE may keep/release the stored CHO-with-CPAC configurations according to the lists.

In some implementations, the UE may keep/release the stored CHO-with-CPAC configurations the conditional configuration IDs of which are included in one of the lists.

In some implementations, the UE may release the stored CHO-with-CPAC configurations the conditional configuration IDs of which are included in one of the lists and which are not associated with the new PCell.

In some implementations, the UE may keep the stored CHO-with-CPAC configurations the conditional configuration IDs of which are included in one of the lists and which are associated with the new PCell.

In some implementations, the UE may release the stored CHO-with-CPAC configurations the conditional configuration IDs of which are included in neither of the lists.

In some implementations, if the SA type indicator list includes three lists of conditional configuration IDs, the UE may keep/release the stored CHO-with-CPAC configurations according to the lists.

In some implementations, the UE may keep/release the stored CHO-with-CPAC configurations the conditional configuration IDs of which are included in one of the lists.

In some implementations, the UE may release the stored CHO-with-CPAC configurations the conditional configuration IDs of which are included in one of the lists and which are not associated with the new PCell.

In some implementations, the UE may keep the stored CHO-with-CPAC configurations the conditional configuration IDs of which are included in one of the lists and which are associated with the new PCell.

In some implementations, the UE may keep some of the stored conditional configurations after completing the execution (e.g., the completion of random access procedure with the new PSCell).

In some implementations, if the SA type indicator of a CHO-with-CPAC configuration is ‘SUBSEQUENT_CHO’, the UE may keep all the information (e.g., the conditional configuration ID, the MCG and SCG configurations, the execution condition(s) for the PCell, and the execution condition(s) for the PSCell), and the UE may store the kept information.

In some implementations, if the SA type indicator of a CHO-with-CPAC configuration is ‘SUBSEQUENT_CPAC’, the UE may remove the execution condition(s) for the PCell, keep the other information (e.g., the conditional configuration ID, the MCG and SCG configurations, and the execution condition(s) for the PSCell), and store the kept information.

In some implementations, if a satisfied CHO-only configuration is selected by the UE, the UE may perform a random access procedure with the PCell. If the random access procedure is successful (e.g., a monitoring timer does not expire before the UE complete the random access procedure), the UE may complete the connections with the new PCell, and the UE may continue the data transmission to and/or reception from the cells configured in the new MCG configuration.

In some implementations, the UE may keep/release some of the stored conditional configurations upon completing the random access procedure with the new PCell.

In some implementations, the UE may release all the stored CHO-only configurations and all the CHO-with-SCG configurations.

In some implementations, the UE may release the stored CHO-with-CPAC configurations without SA type indicators.

In some implementations, the UE may release the stored CHO-with-CPAC configurations the SA type indicators of which are ‘FALSE’.

In some implementations, the UE may release the stored CHO-with-CPAC configurations the SA type indicators of which are ‘SUBSEQUENT_CPAC’.

In some implementations, the UE may release the stored CHO-with-CPAC configurations the SA type indicators of which are ‘SUBSEQUENT_CPAC’ and which are not associated with the new PCell.

In some implementations, the UE may keep the stored CHO-with-CPAC configurations the SA type indicators of which are ‘SUBSEQUENT_CPAC’ and which are associated with the new PCell.

In some implementations, the UE may keep the stored CHO-with-CPAC configurations the SA type indicators of which are ‘SUBSEQUENT_CHO’.

In some implementations, the UE may check the stored SA type indicator list when deciding which CHO-with-CPAC configuration to be released.

In some implementations, if the SA type indicator list includes two lists of conditional configuration IDs, the UE may keep/release the stored CHO-with-CPAC configurations according to the lists.

In some implementations, the UE may keep/release the stored CHO-with-CPAC configurations the conditional configuration IDs of which are included in one of the lists.

In some implementations, the UE may release the stored CHO-with-CPAC configurations the conditional configuration IDs of which are included in one of the lists and which are not associated with the new PCell.

In some implementations, the UE may keep the stored CHO-with-CPAC configurations the conditional configuration IDs of which are included in one of the lists and which are associated with the new PCell.

In some implementations, the UE may release the stored CHO-with-CPAC configurations the conditional configuration IDs of which are included in neither of the lists.

In some implementations, if the SA type indicator list includes three lists of conditional configuration IDs, the UE may keep/release the stored CHO-with-CPAC configurations according to the lists.

In some implementations, the UE may keep/release the stored CHO-with-CPAC configurations the conditional configuration IDs of which are included in one of the lists.

In some implementations, the UE may release the stored CHO-with-CPAC configurations the conditional configuration IDs of which are included in one of the lists and which are not associated with the new PCell.

In some implementations, the UE may keep the stored CHO-with-CPAC configurations the conditional configuration IDs of which are included in one of the lists and which are associated with the new PCell.

In some implementations, the UE may keep some of the stored conditional configurations after completing the execution (e.g., the completion of random access procedure with the PCell).

In some implementations, if the SA type indicator of a CHO-with-CPAC configuration is ‘SUBSEQUENT_CHO’, the UE may keep all the information (e.g., the conditional configuration ID, the MCG and SCG configurations, the execution condition(s) for the PCell, and the execution condition(s) for the PSCell), and the UE may store the kept information.

In some implementations, if the SA type indicator of a CHO-with-CPAC configuration is ‘SUBSEQUENT_CPAC’, the UE may remove the execution condition(s) for the PCell, keep the other information (e.g., the conditional configuration ID, the MCG and SCG configurations, and the execution condition(s) for the PSCell), and store the kept information.

In some implementations, upon applying the selected conditional configuration, the UE may transmit an RRC message (e.g., an RRC Reconfigure Complete message) to the source node (e.g., the source MN) to inform the network that the RRC configuration is changed. In some implementations, there may be some XnAP signaling exchange between the network nodes once the source node receives the RRC message from the UE.

In some implementations, the RRC message from the UE to the source node (e.g., the source MN) may include the conditional (re) configuration ID of the applied conditional configuration.

In some implementations, upon receiving the RRC message from the UE, the source node (e.g., the source MN) may send XnAP messages to some of the candidate target MNs to cancel the prepared MCG configurations. In some implementations, upon receiving the XnAP message from the source node (e.g., the source MN), if associated candidate target SNs have been prepared and configured, the candidate target MN may transmit XnAP messages to the associated candidate target SNs to cancel the prepared SCG configurations.

In some implementations, the source node (e.g., the source MN) may determine which CHO-with-CPAC configurations may be released by the UE. The source node (e.g., the source MN) may send cancellation messages (e.g., XnAP messages) to the candidate target MNs which are associated with these CHO-with-CPAC configurations to indicate the candidate target MNs to cancel the prepared CHO-with-CPAC configurations. In some implementations, upon receiving the cancellation message, the candidate target MN may cancel the prepared MCG configuration and, if SCG configuration is configured for the UE, the candidate target MN may send the cancellation message to the associated SNs. In some implementations, upon receiving the cancellation message, the associated SNs may cancel the prepared SCG configurations.

In some implementations, upon determining which CHO-with-CPAC configurations may be released by the UE, the source node (e.g., the source MN) may include the selective activation type of the stored CHO-with-CPAC configurations.

In some implementations, if the selective activation type of a stored CHO-with-CPAC configuration is ‘FALSE’, the source node (e.g., the source MN) may determine that the CHO-with-CPAC configuration may be released by the UE.

In some implementations, if the selective activation type of a stored CHO-with-CPAC configuration is ‘SUBSEQUENT_CPAC’, and if the CHO-with-CPAC configuration is not associated with the new PCell, the source node (e.g., the source MN) may determine that the CHO-with-CPAC configuration may be released by the UE.

In some implementations, if a CHO-with-CPAC configuration does not include, or is not associated with, a selective activation type, the source node (e.g., the source MN) may determine that the CHO-with-CPAC configuration may be released by the UE.

In some implementations, the cancellation message from the source node (e.g., the source MN) to a candidate target MN may include a list of conditional configuration IDs to indicate the CHO-with-CPAC configurations to be cancelled. In some implementations, the conditional configuration ID is logically common to the source node (e.g., the source MN) and the candidate target MN.

In some implementations, the cancellation message from a candidate target MN to a candidate target SN may include a list of conditional configuration IDs to indicate the CHO-with-CPAC configurations to be cancelled. In some implementations, the conditional configuration ID is logically common to the candidate target MN and the candidate target SN.

In some implementations, after completing the connection to the new MCG and/or SCG (e.g., completing the random access procedure with the associated cells in the selected conditional configuration) and releasing some of the conditional configurations, the UE may start evaluating the execution condition(s) of the kept conditional configurations.

### New IE to Differentiate the Selective Activation

In some implementations, upon receiving the messages from the candidate target MNs, the source node (e.g., the source MN) may transmit the conditional configurations to the UE via RRC signaling.

In some implementations, the source node may inform, via RRC signaling, the UE of multiple CHO-only configurations, and/or CHO-with-SCG configurations, and/or CHO-with-CPAC configurations, and/or subsequent CHO-with-CPAC configurations, and/or CHO-with-subsequent-CPAC configurations.

In some implementations, a subsequent CHO-with-CPAC configuration may have the same structure as a CHO-with-CPAC configuration, but the subsequent CHO-with-CPAC configuration may further include a new IE, which may be different from and may substitute the one in a CHO-with-CPAC configuration, so that the UE may differentiate a subsequent CHO-with-CPAC configuration from a CHO-with-CPAC configuration.

For example, a subsequent CHO-with-CPAC configuration may include a new conditional configuration ID IE (e.g., the condReconfigId-r19 IE) for a UE to differentiate a subsequent CHO-with-CPAC configuration from a CHO-with-CPAC configuration.

Additionally or alternatively, the subsequent CHO-with-CPAC configuration may include a new execution condition IE for PCell (e.g., the condExecutionCond-r19 IE) for a UE to differentiate a subsequent CHO-with-CPAC configuration from a CHO-with-CPAC configuration. Additionally or alternatively, the subsequent CHO-with-CPAC configuration may include a new conditional RRC reconfiguration IE (e.g., the condRRCReconfig-r19 IE) for a UE to differentiate a subsequent CHO-with-CPAC configuration from a CHO-with-CPAC configuration.

In some implementations, the source node (e.g., the source MN) may transmit all the conditional configurations via multiple RRC messages.

In some implementations, the source node (e.g., the source MN) may transmit all the conditional configurations via a single RRC message.

In some implementations, the source node (e.g., the source MN) may transmit a single type of conditional configurations via a single RRC message. For example, the source node (e.g., the source MN) may include all the CHO-only configurations, or all the CHO-with-SCG configurations, or all the CHO-with-CPAC configurations, or all the subsequent CHO-with-CPAC configurations, or all the CHO-with-subsequent-CPAC configurations in a single RRC message.

In some implementations, the source node (e.g., the source MN) may transmit multiple types of conditional configurations via a single RRC message.

In some implementations, a CHO-with-subsequent-CPAC configuration may have the same structure as a CHO-with-CPAC configuration, but a CHO-with-subsequent-CPAC configuration may further include a new IE, which may be different from and may substitute the one in a CHO-with-CPAC configuration, so that the UE may differentiate a CHO-with-subsequent-CPAC configuration from a CHO-with-CPAC configuration. In some implementations, a CHO-with-subsequent-CPAC configuration may include a new execution condition IE for PSCell (e.g., the condExecutionCondSCG-r19 IE) for a UE to differentiate a CHO-with-subsequent-CPAC configuration from a CHO-with-CPAC configuration.

In some implementations, a UE may be configured with one or multiple CHO-with-CPAC configurations, one or multiple subsequent CHO-with-CPAC configurations, and one or multiple CHO-with-subsequent-CPAC configurations at the same time.

In some implementations, a UE may receive the CHO-with-CPAC configurations, the subsequent CHO-with-CPAC configurations, and the CHO-with-subsequent-CPAC configurations in the same RRC signaling.

In some implementations, a UE may receive the CHO-with-CPAC configurations, the subsequent CHO with a CPAC, and the CHO-with-subsequent-CPAC configurations in different RRC signaling s: one including all the CHO-with-CPAC configurations, another one including all the subsequent CHO-with-CPAC configurations, and the other one including all the CHO-with-subsequent-CPAC configurations.

In some implementations, upon receiving the conditional configurations (e.g., the CHO-only configurations, the CHO-with-SCG configurations, the CHO-with-CPAC configurations, the subsequent CHO-with-CPAC configurations, the CHO-with-subsequent-CPAC configurations) via RRC signaling, the UE may store and apply a part of the received conditional configurations. In some implementations, the UE may store the MCG and SCG configurations of the received conditional configurations and apply the execution condition(s) of the received conditional configurations.

In some implementations, during the evaluation of the execution condition(s), if there is one or more satisfied conditional configurations, the UE may select and apply one of the conditional configurations by itself (e.g., randomly, based on UE implementation). In some implementations, during the evaluation of the execution condition(s), if there is one or more satisfied conditional configurations, the UE may select and apply one of the conditional configurations based on a predefined rule (e.g., select and apply the satisfied conditional configuration with the lowest (or highest) configuration ID).

In some implementations, if a CHO-with-SCG configuration, or a CHO-with-CPAC configuration, or a subsequent CHO-with-CPAC configuration, or a CHO-with-subsequent-CPAC configuration is selected by the UE, the UE may perform the random access procedure with the PCell associated with the selected conditional configuration. If the random access is successful (e.g., a monitoring timer does not expire before the UE completes the random access procedure), the UE may start to perform the random access procedure with the PSCell associated with the selected conditional configuration. If the random access is successful (e.g., a monitoring timer does not expire before the UE completes the random access procedure), the UE may complete the connection with both the new PCell and the new PSCell, and the UE may continue the data transmission to and/or reception from the cells configured in the new MCG and SCG configuration.

In some implementations, the UE may keep/release some of the stored conditional configurations upon completing the random access procedure with the new PCell.

In some implementations, the UE may release all the stored CHO-only configurations, all the stored CHO-with-SCG configurations, and all the stored CHO-with-CPAC configurations. In some implementations, the UE may determine that a stored conditional configuration is a CHO-with-CPAC configuration if the conditional configuration possesses the same structure as a CHO-with-CPAC configuration, and if the conditional configuration does not include any new IEs (e.g., the condReconfigId-r19 IE, the condExecutionCond-r19 IE, the condRRCReconfig-r19 IE, and/or the condExecutionCondSCG-r19 IE).

In some implementations, the UE may release the stored CHO-with-subsequent-CPAC configurations that are not associated with the new PCell. In some implementations, the UE may determine that a stored conditional configuration is a CHO-with-subsequent-CPAC configuration if the conditional configuration possesses the same structure as a CHO-with-CPAC configuration, and if the execution condition IE for the PSCell is a new IE (e.g., the condExecutionCondSCG-r19 IE).

In some implementations, the UE may keep the stored CHO-with-subsequent-CPAC configurations that are associated with the new PCell. In some implementations, the UE may determine that a stored conditional configuration is a CHO-with-subsequent-CPAC configuration if the conditional configuration possesses the same structure as a CHO-with-CPAC configuration, and if the execution condition IE for the PSCell is a new IE (e.g., the condExecutionCondSCG-r19 IE).

In some implementations, the UE may keep the stored subsequent CHO-with-CPAC configurations. In some implementations, the UE may determine that a stored conditional configuration is a subsequent CHO-with-CPAC configuration if the conditional configuration possesses the same structure as a CHO-with-CPAC configuration, and if the conditional configuration includes at least one of the following new IEs: the new conditional configuration ID IE (e.g., the condReconfigId-r19 IE), the new execution condition IE for the PCell (e.g., the condExecutionCond-r19 IE), and the new RRC reconfiguration IE (e.g., the condRRCReconfig-r19 IE).

In some implementations, the UE may keep all the stored conditional configurations (e.g., the CHO-only, the CHO with SCG, the CHO with a CPAC, the subsequent CHO with a CPAC, and the CHO-with-subsequent-CPAC configurations) after it completes the random access procedure with the new PCell. In some implementations, the UE may keep/release some of the stored conditional configurations upon completing the random access procedure with the new PSCell.

In some implementations, the UE may release all the stored CHO-only configurations, all the stored CHO-with-SCG configurations, and all the stored CHO-with-CPAC configurations. In some implementations, the UE may determine that a stored conditional configuration is a CHO-with-CPAC configuration if the conditional configuration possesses the same structure as a CHO-with-CPAC configuration, and if the conditional configuration does not include any new IEs (e.g., the condReconfigId-r19 IE, the condExecutionCond-r19 IE, the condRRCReconfig-r19 IE, the condExecutionCondSCG-r19 IE).

In some implementations, the UE may release the stored CHO-with-subsequent-CPAC configurations that are not associated with the new PCell. In some implementations, the UE may determine that a stored conditional configuration is a CHO-with-subsequent-CPAC configuration if the conditional configuration possesses the same structure as a CHO-with-CPAC configuration, and if the execution condition IE for the PSCell is a new IE (e.g., the condExecutionCondSCG-r19 IE).

In some implementations, the UE may keep the stored CHO-with-subsequent-CPAC configurations that are associated with the new PCell. In some implementations, the UE may determine that a stored conditional configuration is a CHO-with-subsequent-CPAC configuration if the conditional configuration possesses the same structure as a CHO-with-CPAC configuration, and if the execution condition IE for the PSCell is a new IE (e.g., the condExecutionCondSCG-r19 IE).

In some implementations, the UE may keep the stored subsequent CHO-with-CPAC configurations. In some implementations, the UE may determine that a stored conditional configuration is a subsequent CHO-with-CPAC configuration if the conditional configuration possesses the same structure as a CHO-with-CPAC configuration, and if the conditional configuration includes at least one of the following new IEs: the new conditional configuration ID IE (e.g., the condReconfigId-r19 IE), the new execution condition IE for the PCell (e.g., the condExecutionCond-r19 IE), and the new RRC reconfiguration IE (e.g., the condRRCReconfig-r19 IE).

In some implementations, the UE may keep some of the stored conditional configurations after completing the execution (e.g., the completion of random access procedure with the PSCell).

In some implementations, if the kept conditional configuration is a subsequent CHO-with-CPAC configuration, the UE may keep all the information (e.g., the conditional configuration ID, the MCG and SCG configurations, the execution condition(s) for the PCell, and the execution condition(s) for the PSCell), and the UE may store the kept information.

In some implementations, if the kept conditional configuration is a CHO-with-subsequent-CPAC configuration, the UE may remove the execution condition(s) for the PCell, keep the other information (e.g., the conditional configuration ID, the MCG and SCG configurations, and the execution condition(s) for the PSCell), and store the kept information.

In some implementations, if a satisfied CHO-only configuration is selected by the UE, the UE may perform the random access procedure with the PCell. If the random access is successful (e.g., a monitoring timer does not expire before the UE complete the random access procedure), the UE may complete the connections with the new PCell, and the UE may continue the data transmission to and/or reception from the cells configured in the new MCG configuration.

In some implementations, the UE may keep/release some of the stored conditional configurations upon completing the random access procedure with the new PCell.

In some implementations, the UE may release all the stored CHO-only configurations, all the stored CHO-with-SCG configurations, and all the stored CHO-with-CPAC configurations. In some implementations, the UE may determine that a stored conditional configuration is a CHO-with-CPAC configuration if the conditional configuration possesses the same structure as a CHO-with-CPAC configuration, and if the conditional configuration does not include any new IEs (e.g., the condReconfigId-r19 IE, the condExecutionCond-r19 IE, the condRRCReconfig-r19 IE, and/or the condExecutionCondSCG-r19 IE).

In some implementations, the UE may release the stored CHO-with-subsequent-CPAC configurations that are not associated with the new PCell. In some implementations, the UE may determine that a stored conditional configuration is a CHO-with-subsequent-CPAC configuration if the conditional configuration possesses the same structure as a CHO-with-CPAC configuration, and if the execution condition IE for the PSCell is a new IE (e.g., the condExecutionCondSCG-r19 IE).

In some implementations, the UE may keep the stored CHO-with-subsequent-CPAC configurations that are associated with the new PCell. In some implementations, the UE may determine that a stored conditional configuration is a CHO-with-subsequent-CPAC configuration if the conditional configuration possesses the same structure as a CHO-with-CPAC configuration, and if the execution condition IE for the PSCell is a new IE (e.g., the condExecutionCondSCG-r19 IE).

In some implementations, the UE may keep the stored subsequent CHO-with-CPAC configurations. In some implementations, the UE may determine that a stored conditional configuration is a subsequent CHO-with-CPAC configuration if the conditional configuration possesses the same structure as a CHO-with-CPAC configuration, and if the conditional configuration includes at least one of the following new IEs: the new conditional configuration ID IE (e.g., the condReconfigId-r19 IE), the new execution condition IE for the PCell (e.g., the condExecutionCond-r19 IE), and the new RRC reconfiguration IE (e.g., the condRRCReconfig-r19 IE)

In some implementations, the UE may keep some of the stored conditional configurations after completing the execution (e.g., the completion of random access procedure with the PCell).

In some implementations, if the kept conditional configuration is a subsequent CHO-with-CPAC configuration, the UE may keep all the information (e.g., the conditional configuration ID, the MCG and SCG configurations, the execution condition(s) for the PCell, and the execution condition(s) for the PSCell), and the UE may store the kept information.

In some implementations, if the kept conditional configuration is a CHO-with-subsequent-CPAC configuration, the UE may remove the execution condition(s) for the PCell, keep the other information (e.g., the conditional configuration ID, the MCG and SCG configurations, and the execution condition(s) for the PSCell), and store the kept information.

In some implementations, if the kept conditional configuration is a CHO-with-subsequent-CPAC configuration, the UE may keep all the information (e.g., the conditional configuration ID, the MCG and SCG configurations, the execution condition(s) for the PCell, and the execution condition(s) for the PSCell), and the UE may store the kept information. In some implementations, when evaluating the execution condition(s) of the kept conditional configuration, the UE may ignore the execution condition(s) for the PCell and may only evaluate the execution condition(s) for the PSCell.

In some implementations, a UE may be configured with one or more of various types of conditional handover configurations. The various types of conditional handover configurations may include, but are not limited to, the CHO-only configuration(s), the CHO-with-SCG configuration(s), the CHO-with-CPAC configuration(s), the subsequent CHO-with-CPAC configuration(s), and the CHO-with-subsequent-CPAC configuration(s). The subsequent CHO-with-CPAC configuration may be the same as the CHO-with-CPAC configuration except that the execution condition for the (candidate target) PCell is substituted by a new IE (e.g., the condExecutionCond-r19 IE). The CHO-with-subsequent-CPAC configuration may be the same as the CHO-with-CPAC configuration except that the execution condition for the (candidate target) PSCell is substituted by a new IE (e.g., the condExecutionCondSCG-r19 IE).

In some implementations, the source node (e.g., the source MN) may configure the UE with the conditional configurations via multiple RRC messages, each of which may include one or more than one types of conditional configurations (e.g., the CHO-only configurations, the CHO-with-SCG configurations, the CHO-with-CPAC configurations, the subsequent CHO-with-CPAC configurations, and the CHO-with-subsequent-CPAC configurations).

In some implementations, upon the reception of the conditional configurations, the UE may store the information of conditional configurations and start to evaluate the execution conditions of the conditional configurations.

In some implementations, upon the execution of a satisfied conditional configuration, the UE may keep/release the conditional configurations according to the types of the conditional configurations by following specific rules, such as the ones outlined below:
1. The UE releases all the CHO-only configurations.
2. The UE releases all the CHO-with-SCG configurations,
3. The UE releases all the CHO-with-CPAC configurations.
4. The UE keeps all the subsequent CHO-with-CPAC configurations.
5. The UE releases the CHO-with-subsequent-CPAC configurations that are not associated with the new PCell.
6. The UE keeps the CHO-with-subsequent-CPAC configurations that are associated with the new PCell.

In some implementations, after keeping/releasing the conditional configurations, the UE may store all the information of the subsequent CHO-with-CPAC configurations.

In some implementations, after keeping/releasing the conditional configurations, the UE may remove the execution condition for PCell and store the remaining information of the CHO-with-subsequent-CPAC configurations.

It should be noted that the system information may be associated with the serving cell and/or the system information may be associated with the target cell.

It should be noted that a condition (e.g., an execution condition of a conditional configuration) may be considered to be satisfied if the configured measurement event (e.g., the RSRP value of the target cell is higher than a threshold (e.g., an RRC-configured RSRP value)) remains the same for a configured time-to-trigger duration.

In some implementations, one or more monitoring timers may be configured for an MCG or an SCG in a conditional configuration (e.g., a CHO-only configuration, a CHO-with-SCG configuration, a CHO-with-CPAC configuration, a subsequent CHO-with-CPAC configuration, or a CHO-with-subsequent-CPAC configuration). For example, a CHO-only configuration may include a single monitoring timer. In some implementations, other conditional configurations, such as the CHO-with-SCG configuration, the CHO-with-CPAC configuration, the subsequent CHO-with-CPAC configuration, and the CHO-with-subsequent-CPAC configuration may include two monitoring timers: one timer is dedicated for the MCG configuration and the other timer is dedicated for the SCG configuration. The value of the monitoring timer may be included in the conditional configuration. Once a conditional configuration is selected and executed by the UE, the UE may start the corresponding monitoring timer and set the initial value as indicated in the conditional configuration. When the UE completes the random access procedure (e.g., upon the successful reception of the contention resolution at the MAC entity), the UE may stop the monitoring timer. When the monitoring timer expires, the UE may declare a radio link failure and start an RRC establishment/reestablishment procedure.

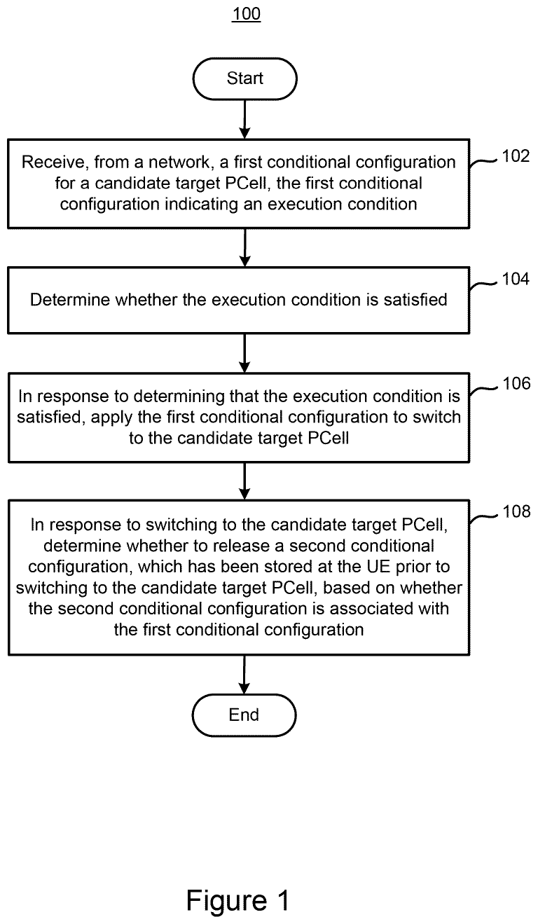

FIG. 1 is a flowchart of method/process 100 for mobility management, according to an example implementation of the present disclosure. It should be noted that although actions 102, 104, 106, and 108 are illustrated as separate actions, being represented by independent blocks, in FIG. 1, these separately illustrated actions should not be construed as necessarily order-dependent. The order in which the actions are performed in FIG. 1 is not intended to be construed as a limitation, and any number of the disclosed blocks may be combined in any order to implement the method, or an alternative method. Moreover, each of actions 102, 104, 106, and 108 may be performed independent of other actions and may be omitted in some implementations of the present disclosure. Process 100 may be performed by a UE.

In action 102, the process 100 may start by receiving, from a network, a first conditional configuration for a candidate target Primary Cell (PCell). The first conditional configuration may indicate an execution condition. For example, the first conditional configuration may include a CHO-only configuration, a CHO-with-SCG configuration, a CHO-with-CPAC configuration, a CHO-with-subsequent-CPAC configuration, and/or a subsequent CHO-with-CPAC configuration.

In action 104, the UE may determine whether the execution condition is satisfied. For example, the execution condition may be considered as satisfied if the RSRP value of the candidate target PCell meets, or exceeds, a specific threshold and remains the same for a configured time-to-trigger duration.

In action 106, in response to determining that the execution condition is satisfied, the UE may apply the first conditional configuration to switch to the candidate target PCell. This switching process may be executed through the CHO, as described in the present disclosure. During the CHO, the UE may autonomously initiate the handover to the candidate target PCell without waiting for further (explicit) signaling from the network.

In action 108, in response to switching to the candidate target PCell, the UE may determine whether to release a second conditional configuration, which has been stored at the UE prior to switching to the candidate target PCell. The UE may make such a determination based on whether the second conditional configuration is associated with the first conditional configuration. Process 100 may then end.

In some implementations, the second conditional configuration may be associated with a candidate target PSCell. For example, if the second conditional configuration remains active (e.g., has not been released by the UE yet), and the execution condition(s) in the second conditional configuration is satisfied, the UE may initiate a handover to the candidate target PSCell or add the candidate target PSCell as a new PSCell by applying the second conditional configuration.

In some implementations, applying the first conditional configuration to switch to the candidate target PCell may include the UE performing an RA procedure based on the first conditional configuration.

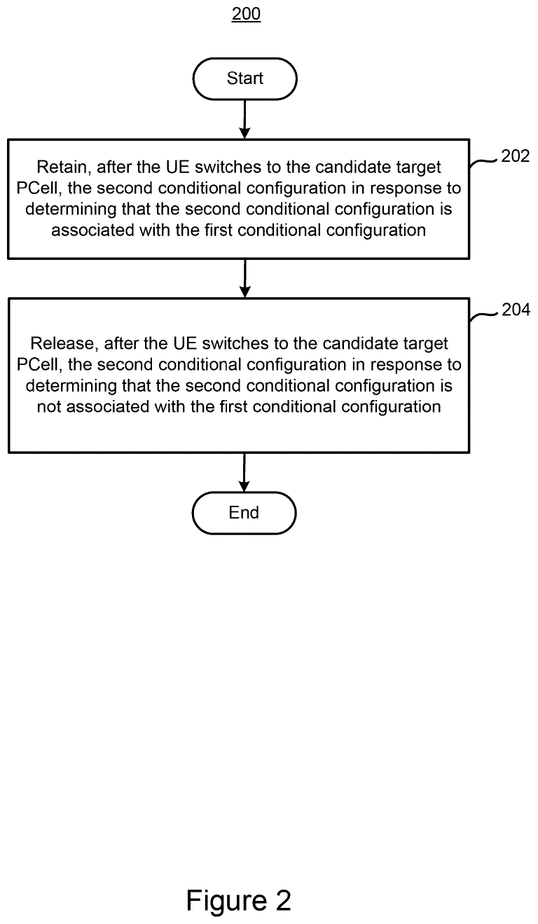

FIG. 2 is a flowchart of method/process 200 for mobility management, according to an example implementation of the present disclosure. Process 200 may be seen as either a continuation of the earlier described methods/processes, including process 100, with additional detailed actions for mobility enhancement, or as a standalone approach offering a different or more detailed mechanism to enhance mobility. Moreover, process 200 may be integrated with process 100 and/or other methods/processes described in the present disclosure. Additionally, process 200 uses terminology that is consistent with or corresponds to the terminology utilized in process 100. Process 200 may be performed by a UE.

In action 202, process 200 may start by retaining, after the UE switches to the candidate target PCell, the second conditional configuration in response to determining that the second conditional configuration is associated with the first conditional configuration.

In action 204, process 200 may release, after the UE switches to the candidate target PCell, the second conditional configuration in response to determining that the second conditional configuration is not associated with the first conditional configuration. Process 200 may then end.

For example, the UE may retain the stored second conditional configuration if its corresponding conditional configuration ID is included in a specific list and if the second conditional configuration is associated with the candidate target PCell. Conversely, if the conditional configuration ID of the second conditional configuration is not included in the specific list, or if the second conditional configuration is not associated with the candidate target PCell, the UE may consider the second conditional configuration as not being associated with the first conditional configuration and may release the second conditional configuration accordingly.

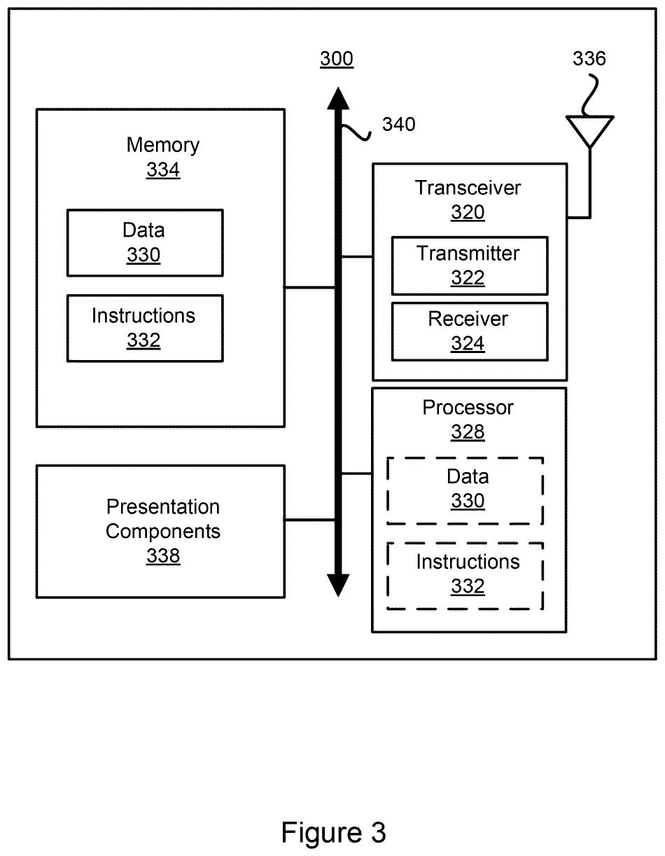

FIG. 3 is a block diagram illustrating node 300 for wireless communications, in accordance with various aspects of the present disclosure. As illustrated in FIG. 3, node 300 may include transceiver 320, processor 328, memory 334, one or more presentation components 338, and at least one antenna 336. Node 300 may also include a radio frequency (RF) spectrum band module, a BS communications module, a network communications module, and a system communications management module, Input/Output (I/O) ports, I/O components, and a power supply (not illustrated in FIG. 3).

Each of the components may directly or indirectly communicate with each other over one or more buses 340. Node 300 may be a UE or a BS that performs various functions disclosed with reference to FIGS. 1 through 2.

Transceiver 320 has transmitter 322 (e.g., transmitting/transmission circuitry) and receiver 324 (e.g., receiving/reception circuitry) and may be configured to transmit and/or receive time and/or frequency resource partitioning information. Transceiver 320 may be configured to transmit in different types of subframes and slots including, but not limited to, usable, non-usable, and flexibly usable subframes and slot formats. Transceiver 320 may be configured to receive data and control channels.

Node 300 may include a variety of computer-readable media. Computer-readable media may be any available media that may be accessed by node 300 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the above-listed components should also be included within the scope of computer-readable media.

Memory 334 may include computer-storage media in the form of volatile and/or non-volatile memory. Memory 334 may be removable, non-removable, or a combination thereof. Example memory may include solid-state memory, hard drives, optical-disc drives, etc. As illustrated in FIG. 3, memory 334 may store a computer-readable and/or computer-executable instructions 332 (e.g., software codes) that are configured to, when executed, cause processor 328 to perform various functions disclosed herein, for example, with reference to FIGS. 1 through 2. Alternatively, instructions 332 may not be directly executable by processor 328 but may be configured to cause node 300 (e.g., when compiled and executed) to perform various functions disclosed herein.

Processor 328 (e.g., having processing circuitry) may include an intelligent hardware device, e.g., a Central Processing Unit (CPU), a microcontroller, an ASIC, etc. Processor 328 may include memory. Processor 328 may process data 330 and instructions 332 received from memory 334, and information transmitted and received via transceiver 320, the baseband communications module, and/or the network communications module. Processor 328 may also process information to send to transceiver 320 for transmission via antenna 336 to the network communications module for transmission to a CN.

One or more presentation components 338 may present data indications to a person or another device. Examples of presentation components 338 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a User Equipment (UE) for mobility management, the method comprising:
receiving, from a network, a first conditional configuration for a candidate target Primary Cell (PCell), the first conditional configuration indicating an execution condition;
determining whether the execution condition is satisfied;
in response to determining that the execution condition is satisfied, applying the first conditional configuration to switch to the candidate target PCell; and
in response to switching to the candidate target PCell, determining whether to release a second conditional configuration, which has been stored at the UE prior to switching to the candidate target PCell, based on whether the second conditional configuration is associated with the first conditional configuration.

2. The method of claim 1, further comprising:
retaining, after switching to the candidate target PCell, the second conditional configuration in response to determining that the second conditional configuration is associated with the first conditional configuration; and
releasing, after switching to the candidate target PCell, the second conditional configuration in response to determining that the second conditional configuration is not associated with the first conditional configuration.

3. The method of claim 1, wherein the second conditional configuration is associated with a candidate target Primary Secondary Cell (PSCell).

4. The method of claim 1, wherein applying the first conditional configuration to switch to the candidate target PCell comprises:
performing a Random Access (RA) procedure based on the first conditional configuration.

5. A User Equipment (UE) for mobility management, the UE comprising:
at least one processor; and
at least one non-transitory computer-readable medium coupled to the at least one processor and storing one or more computer-executable instructions that, when executed by the at least one processor, cause the UE to:
receive, from a network, a first conditional configuration for a candidate target Primary Cell (PCell), the first conditional configuration indicating an execution condition;
determine whether the execution condition is satisfied;
in response to determining that the execution condition is satisfied, apply the first conditional configuration to switch to the candidate target PCell; and
in response to switching to the candidate target PCell, determine whether to release a second conditional configuration, which has been stored at the UE prior to switching to the candidate target PCell, based on whether the second conditional configuration is associated with the first conditional configuration.

6. The UE of claim 5, wherein the one or more computer-executable instructions, when executed by the at least one processor, further cause the UE to:
retain, after switching to the candidate target PCell, the second conditional configuration in response to determining that the second conditional configuration is associated with the first conditional configuration; and
release, after switching to the candidate target PCell, the second conditional configuration in response to determining that the second conditional configuration is not associated with the first conditional configuration.

7. The UE of claim 5, wherein the second conditional configuration is associated with a candidate target Primary Secondary Cell (PSCell).

8. The UE of claim 5, wherein applying the first conditional configuration to switch to the candidate target PCell comprises:
performing a Random Access (RA) procedure based on the first conditional configuration.
